(19) United States
(12) Patent Application Publication
(10) Pub. No.: US 2008/0306854 A1
(43) Pub. Date: Dec. 11, 2008

(54) Event Timing Mechanisms for Dutch Auction of Securities

(75) Inventors: Alan Katz, Dallas, TX (US); Whitney White, New York, NY (US)

Correspondence Address: BROMBERG & SUNSTEIN LLP, 125 SUMMER STREET, BOSTON, MA, 02110-1618, US

(73) Assignee: W.R. HAMBRECHT + CO., LLC, San Francisco, CA (US)

(21) Appl. No.: 11/758,148

(22) Filed: Jun. 5, 2007

(51) Int. Cl. G06Q 40/00

(52) U.S. Cl. 705/37

(57) ABSTRACT

A method for auctioning securities defines an auction start time and an auction end time. The time therebetween is defined by time bucket intervals and transparency intervals. At the auction start time, a real-time auction of securities over a communications network begins. During each time bucket interval bids are received from prospective purchasers, and assigned a time bucket stamp such that bids with the same time stamp are treated as having occurred at the same time. At the end of each transparency interval public bid information related to the auction is updated and made available to the prospective purchasers. After the auction end time, a final auction price for the securities is established based upon the bids made during the auction, and the securities are allocated to the prospective purchasers at the final auction price.

### FIELD OF THE INVENTION

The present invention relates to the field of Internet computer systems for securities auctions.

### BACKGROUND ART

It is desirable that the process of buying and selling initial offerings and large regulated blocks of commodities or securities (hereinafter “securities”) be made more accessible to more investors, be made more price transparent by providing more visibility into the bid and offer process, reduce the costs to issuers and investors and increase the amount of trading in these securities.

A company that has become publicly traded through an initial public offering may raise additional capital through a follow-on offering of securities. In a follow-on offering, the publicly-traded company sells additional equity securities (e.g., shares of common stock) to the public. Typically, these securities are offered to institutional investors at a price discounted from the closing price of the company's stock on the day that the follow-on offering occurs.

An increasing number of follow-on and secondary offerings are done via overnight transaction, whereby the underwriter steps in and buys the entire offering and takes on the risk of finding secondary buyers for the offered shares. The obvious benefit of this approach to the issuer or selling shareholders is that they bear no risk of a broken transaction. The disadvantage to the issuer/selling shareholder is that their cost of capital for obtaining a guaranteed transaction may be higher than their costs for doing a direct-to-market transaction, though both bought and non-bought deals are typically done at a discount to the last quoted market price.

Bought deals are typically only done for the most liquid stocks, since the distribution risks for the underwriter are inversely related to the liquidity. To take the additional underwriting risk associated with a bought deal, the underwriter must determine a price discount that sufficiently compensates for the additional risk. The greater the quantity of stock that the underwriter can lay off to interested buyers simultaneously with the transaction, the smaller the risk assumed by the underwriter. Moreover, the underwriter can engage in derivative transactions to insure against unfavorable market movements in the stock, but these transactions come at a cost that must be comprehended in the discount.

### SUMMARY OF THE INVENTION

Embodiments of the present invention are directed to auctioning securities, including defining an auction start time and an auction end time, the time therebetween being defined by a plurality of transparency intervals. At the auction start time, a real-time auction of securities is commenced over a communications network, including receiving bids from prospective purchasers. At the end of each transparency interval, public bid information related to the auction is updated, and made available to the prospective purchasers. After the auction end time, a final auction price for the securities is established based upon the bids made during the auction, and the securities are allocated to the prospective purchasers at the final auction price.

In further embodiments, the auction may be a multi-round auction. The auction may be further defined by a privacy period between the last update of public bid information and the auction end time, during which bids can be received but no further transparency interval updates are made available to the prospective bidders. The bids may include live bids which specify a number of shares of the securities to be purchased at a current price, and limit bids which specify a number of shares of the securities to be purchased and a maximum price per share.

Embodiments are also directed to an auction having a defined auction start time and an auction end time. The time therebetween is defined by time bucket intervals. At the auction start time, a real-time auction of securities is commenced over a communications network. During each time bucket interval, bids are received from prospective purchasers, and assigned a time bucket stamp such that bids with the same time stamp are treated as having occurred at the same time. After the auction end time, a final auction price for the securities is established based upon the bids made during the auction, and the securities are allocated to the prospective purchasers at the final auction price.

In further such embodiments, the auction may be a multi-round auction. Bids can be received before the auction start time and receive the time bucket stamp for the first time bucket interval. The bids may include live bids which specify a number of shares of the securities to be purchased at a current price, and limit bids which specify a number of shares of the securities to be purchased and a maximum price per share.

Embodiments also include a method for auctioning securities, including defining an auction start time and an auction end time. The time therebetween is defined by time bucket intervals, and transparency intervals. At the auction start time, a real-time auction of securities is commenced over a communications network. During each time bucket interval bids are received from prospective purchasers, and assigned a time bucket stamp such that bids with the same time stamp are treated as having occurred at the same time. At the end of each transparency interval public bid information related to the auction is updated, and made available to the prospective purchasers. After the auction end time, a final auction price for the securities is established based upon the bids made during the auction, and the securities are allocated to the prospective purchasers at the final auction price.

In further such embodiments, the auction may be a multi-round auction. The time bucket interval may equal the transparency interval, or be a multiple of the transparency interval. The auction may be further defined by a privacy period between the last update of public bid information and the auction end time, during which bids can be received but no further transparency interval updates are made available to the prospective bidders.

In some specific embodiments, bids can be received before the auction start time and receive the time bucket stamp for the first time bucket interval. The bids may include live bids which specify a number of shares of the securities to be purchased at a current price, and limit bids which specify a number of shares of the securities to be purchased and a maximum price per share.

### BRIEF DESCRIPTION OF THE DRAWINGS

FIG. 1 shows a high level architectural overview of one specific embodiment of the present invention.

FIG. 2 shows an example of price point aggregation according to an embodiment of the present invention.

FIG. 3 illustrates an example of the post-auction sales credit preference process according to an embodiment.

FIG. 4 illustrates the timeline for an auction according to one specific embodiment.

FIG. 5 shows the auction process according to another embodiment of the present invention.

FIG. 6 shows the workflow process for the Auctioneer according to one embodiment.

FIG. 7 shows the workflow process for sales management in an embodiment.

FIG. 8 shows the workflow process for the auction bidder in an embodiment.

FIG. 9 shows the workflow process for an auction dealer with accounts according to an embodiment.

FIG. 10 shows how a transparency interval can be used in an embodiment.

FIG. 11 shows the concepts of time buckets and time stamps according to an embodiment.

FIG. 12 shows details of an example auction according to an embodiment of the present invention in which all of the offered shares are distributed by bids at or above the final clearing price.

FIG. 13 shows details of an example auction in which the latest bid at the clearing price is only partially filled to complete the allocation of all shares offered.

FIG. 14 shows details of an example auction in which all of the competitive bids are filled and the remaining bids are allocated to a backstop bidder.

FIG. 15 shows details of an example auction which shows that the bids at the clearing price are filled in timestamp order.

FIG. 16 shows a pro rata allocation of the remaining shares among clearing price bids at the same timestamp.

FIG. 17 shows a multiple pro rata allocation of remaining shares.

### DETAILED DESCRIPTION OF SPECIFIC EMBODIMENTS

One specific embodiment of the present invention may meet various specific pre-established functional requirements. Among these,
Auction creation and modification for equity auctions, including support for back-stop bidding and “competitive” limit bids.
The system architecture allows later implementation of an additional bid types (including allocation algorithm and clearing price calculation logic) in a reduced development cycle.
Structured application workflow to support the auction bidding process for electronic retail dealers, small regional retail dealers, underwriter's institutional and retail customers, institutional dealer/partners and co-managers.
Functionality to allow the underwriter's business units varying degrees of control (including full control) over the auction process based on an entitlement structure. For example, an embodiment may allow messages to be broadcast through the administrative interface to users for display in the live-auction bidding/monitoring interface.
Ability to control the external user experience by defining purchase limits, minimum and maximum bid sizes, minimum and maximum bid prices (if any), bid price increments, and bid size increments.
Publishing of transparency bid data and the clearing price in multiples of a time-bucket, which may be a variable of no less than ten seconds.
Publishing of the final allocation results.
Offering a generic dealer adapter to allow for a future implementation of specific dealer back-end connections. This dealer adapter may include an API specification sufficient to provide an implementation framework for potential providers of Qualified Bidding Gateways.

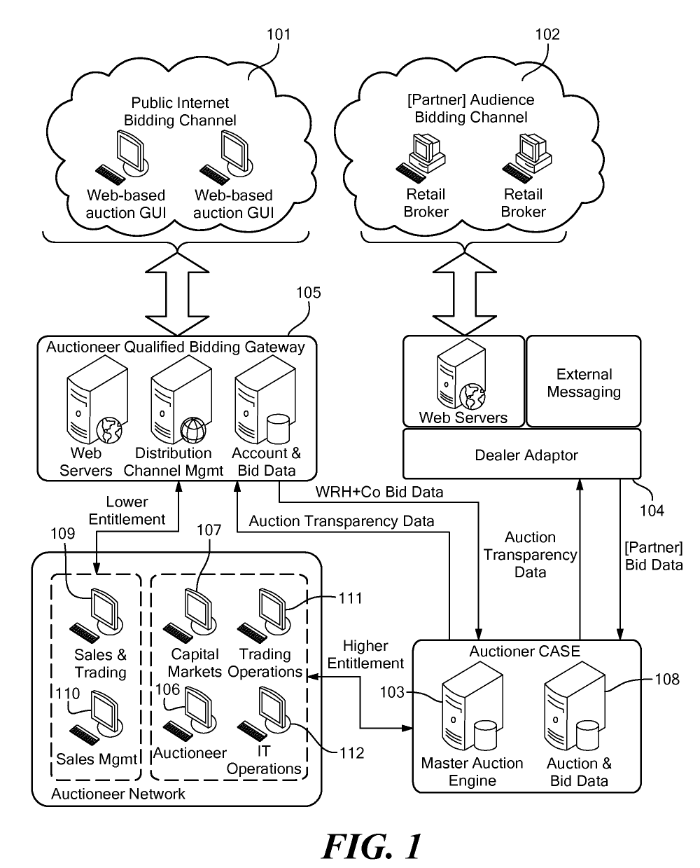

FIG. 1 shows a high level architectural over view of one specific embodiment of the present invention. In FIG. 1, the auction entry point for users is split into two main channels, via an auction web interface either over a Public Internet Channel 101 or through a Partner Channel 102. A Partner Channel 102 can fall under one of three categories:
Bid entry via a flat file upload, before the auction starts, into the Master Auction Engine 103. This may suffice for electronic retail dealers.
Provision of a URL link to the auction application from within a partner application. The partner's customer would be directed to the Public Internet Channel 101 to login. Additional data is required to identify the partner dealer/partner. Functionality to allow a partner/dealer's investor direct seamless access to the auction bidding interface.
Another option for entry through a Partner Channel 102 is either replication or embedding part of the auction GUI into the vendor application. A Dealer Adapter 104 and API specification may be implemented to allow a partner hosted bid-taking interface access into the Master Auction Engine 103. This Dealer Adapter 104 may broker bid data and transparency data between the partner interface and the Master Auction Engine 103. An API specification and Dealer Adapter 104 may be implemented.

Institutional bids are compiled for “transparency data” at the individual bid level. Bid data that is submitted via retail dealers, however, is aggregated at price points. Aggregation of each retail dealer's bids at unique price points may reduce the number of bids in the auction transparency data to the number of unique price points for which their customers bid. This prevents the retail dealers from overwhelming the transparency data while still accurately and transparently reflecting their customers' demand in the auction.

In the example shown in FIG. 1, six defined roles across four business units were identified within the underwriter to support the auction business process. Although Auctioneer 106 is listed as a separate function, it is assumed that this responsibility may fall into an existing business unit, such as Capital Markets 107. Each of these six roles can be categorized into lower and higher levels of entitlement to support the end-to-end process of the auction. Lower levels generally have access only to the data on the underwriter's QBG (Qualified Bidding Gateway) 105 while higher levels have access to the data on the Master Auction Engine 103 and actual auction and Bid Data 108. This may allow those groups to perform administrative roles to control user accounts, bids and auction events. The entitlements that define these six roles and the auction lifecycle determine the application workflow. There may be distinct screens and information that are only accessible to each business unit and forms key stages of each part of the auction that should be completed in succession.

As shown in FIG. 1, the underwriter users that support the auction process are broken into six roles:
Sales and Trading 109
Sales Management 110
Trading Operations 111
Capital Markets 107
Auctioneer 106
IT Operations 112
   The Auctioneer 106 may fall within one of the above business units, most probably an extended function of Capital Markets 107 that is responsible for setting up and finalizing the final stages of the auction. Each role forms a specific function within the auction, with IT Operations 112 defined as a “super-user” role within the entitlement and auction process when needed. The roles and responsibilities of each role follow.

The main role of Sales and Trading 109 at the underwriter or a dealer/partner is to act as a point of auction assistance and guidance for their clients, therefore the restrictions they are operating under follow:
Users of Sales and Trading 109 may have the same auction transparency data view as the investors, but may have no bidding authority. This may enable sales personnel to provide bidding assistance to their clients, without giving these clients an advantage over other auction participants.
Users of Sales and Trading 109 cannot see the account names behind each bid in the auction, nor who is logged into the system.
Users of Sales and Trading 109 may not have the ability to enter bids directly into an auction of behalf of a client at any time. If a sales person receives a bid (via telephone or any other official means of communication), Capital Markets 107 or Trading Operations 111 may enter the bid into the auction on his behalf. The means by which a member of Sales and Trading 109 conveys a customer's bid to Capital Markets 107 and/or Trading Operations 111 is undefined and outside the scope of the system.
Members of Sales and Trading 109 may have the ability to look up client user ID's and passwords for user accounts who share their Dealer ID. Members of Sales and Trading 109 may not have the ability to change any investor's password, see if the client has logged in, or take any action on that client account.

Sales Management 110 covers the system's capabilities with respect to the head of Sales and Trading 109 at the underwriter or at a partner/dealer. As head of the desk, they may have the same rights as the users of Sales and Trading 109 in addition to being able to see, for accounts who share their Dealer ID:
Which customers are logged in to the system.
Which customers are viewing a particular auction.
Which customers have “clicked through” the auction participation agreement, including the timestamp at which the click-thru took place.
Which clients have placed bids in the auction, but no detail with respect to the sizes and prices of these bids.
Customer pre-auction bids only.
The final auction Allocation Results for customers.

The two main responsibilities of Trading Operations 111 are account creation for auction participants and the ability to view auction results for back office processing. For example, the underwriter may use Xtiva for commission management. To facilitate account identification and settlement, a 3-letter Xtiva acronym may be associated with each of the underwriter's auction bidding accounts. The 3-letter code may be captured in the Account/Trailer field associated with each underwriter bidding account. The Dealer ID field may indicate the dealer responsible for the account; for example, the dealer's NASDAQ Broker/Dealer code.

The information that may be captured during the client set-up process for Trading Operations 111 is as follows:
User ID (user ID can be the user's email address)
Password
Dealer ID (NASDAQ Broker/Dealer code
Account ID/Trailer (e.g., Xtiva Acronym or other dealer defined account id)
Account Long Name
Account Contact Name
Phone Number
Purchase Limit Tier [A . . . F]
Coverage Sales Person
Coverage Sales/Trader

The system allows Trading Operations 111 to modify the above information, and accommodates null values for Account Long Name, Phone Number, Coverage Salesperson, Coverage Sales/Trader, and Account Contact Name. Under the supervision of Capital Markets 107/Auctioneer 106, Trading Operations 111 may be able to modify final investor allocations post auction. This includes adding, modifying, and deleting existing allocations.

Trading Operations 111 also is responsible for processing the allocations. The system may offer a Clearing Report to display/print each auction's allocation details. The information on this report includes:
Dealer ID
Account ID/Trailer
Account Long Name
Account Contact Name
Allocation Amount
Price
Coverage Sales Person
Coverage Trader/Sales Trader
Investor Sales Credit Preference
Trade Date (defined as part of the deal terms)
Settlement Date (defined as part of the deal terms)

Capital Markets 107 typically plays a dynamic role throughout the auction process, with the following abilities:
Prior to the auction start, Capital Markets 107 has the ability to define the accounts eligible to participate in each auction.
Capital Markets 107 also has access to all auction data, including the account details underlying all bids from all channels and dealers.
They have full access to user actions so they can see who is currently logged into the auction and the last action that each user took in the auction and its net result; this may consist of the user's bid activity during the auction. This level of information provides an element of security to the auction process, as it allows Capital Markets 107 to monitor for any suspicious activities. Therefore, account information needs to be easily obtained for each client so they can be contacted quickly if required.
Capital Markets 107 also has the ability to eject a bidder from the auction, end the user session, and disable the user bidding account, thus preventing any further participation. Capital Markets 107 may then choose to remove any existing bid that customer may hold in an auction.
To see which underwriter customers have “clicked through” the auction participation agreement, including the timestamp at which the click-thru took place.
Users of Capital Markets 107 may be able to reverse participation agreement click thrus in the event that a material change is made to the auction rule set or prospectus of an auction, prior to the start of that auction.
Users of Capital Markets 107 can look directly at the Master Auction Engine 103 so that they can see all bids that are coming through all bidding channels.
They may have the ability to send out broadcast messages to all users.
Capital Markets 107 may modify, cancel and create bids on behalf of investors; they may not have the ability to specify the time-stamp for any bid.
Once the auction has ended, Capital Markets 107 may also be able to preview allocations before they are published to the general external audience. If any changes to the allocations are identified by use of the allocation calculator, these changes may be performed by an internal underwriter user with the correct entitlements, such as the Auctioneer 106.

The Auctioneer 106 can perform all of the actions of Capital Markets 107, as well as the following auction administration functionality:
The Auctioneer 106 is responsible for setting up the auction prior to the start. This involves uploading the approved rule-set, auction terms, preliminary prospectus and the Issuer's company logo.
The Auctioneer 106 is responsible for entering and modifying any backstop bids.
The Auctioneer 106 has the ability to create, modify, or delete any bid, but, in contrast to Capital Markets 107, is also be able to specify the time-stamp; this bid/time-stamp entry or modification can be performed before, during and after an auction.
The Auctioneer 106 also has the ability to eject a bidder from the auction, end the user session, and disable the user bidding account, thus preventing any further participation. The Auctioneer 106 may then choose to remove any existing bid that customer may hold in an auction.
After the close of the auction, if the final allocation structure requires modification before it is published out to investors, the Auctioneer 106 has access to perform this function. The Auctioneer 106 can add, modify and remove allocations after the auction close. In order to change the allocations, the Auctioneer 106 can see the net effect before finalization, therefore an allocation calculator is required which may allow the Auctioneer 106 to:
   See the allocation change based on different deal sizes (shares available to allocate).
   See the allocation change if bids are removed, modified or added.
   See the allocation change if the Clearing Price is changed.
Once the final allocation has been approved, the Auctioneer 106 performs the manual process of changing the auction state so that individual allocation information is published to each participant. Participants may be able to view only the result of their own bid.
The Auctioneer 106 has the ability to both end the auction early as well as extend it. This includes the ability to re-open after auction close.

IT Operations 112 performs auction support and has full rights to all functions within the auction platform.

Various on-screen queries are available for internal consumption in the system shown in FIG. 1:

### Sales Management Access

Accounts that have signed the participation agreement “click thru” for each auction, including timestamp of signature.
Within each auction, a list of logged in underwriter customers.
Within each auction, a list of accounts who have placed a bid (does not reveal the bid's details)

### Capital Markets/Administrator Access

List of all active accounts/users, broken out by the internal business unit and eternal user categories.
Throughout an auction, dynamic display of the clearing price and its plot as it moves throughout the auction.
Post-auction, the ability to be able to extract the bid history/audit.
During the auction, list of all bid data and the ability to sort within that list.

### Low Priority Reports (not Guaranteed to be Delivered as a Report, But Data Accessible)

Post-auction, the bid history over the duration of the auction displaying the times at which they were changed.
Post-auction, time series of the clearing price movement and history of the histograms as they change every ten seconds.

The types of investors using an embodiment of the present invention may fall into various categories as follows. For each dealer, the system should offer the ability to aggregate pre-auction bids for entry into the live auction.

High Volume Electronic Retail Dealers. Retail dealers may only be able to send/enter pre-bids during the pre-auction bidding window, whose end is defined by a cut-off time on the day of the auction. The retail dealer may provide all bids, including the client account IDs for identification, in a pre-defined flat file to the underwriter. The core auction server may then aggregate the bids at each price point and display them on the auction histogram. Users with full transparency entitlement rights would see these displayed as the retail dealer name. As these are pre-auction bids, they would be assigned a first time period time-bucket.

Neither the brokerage nor their clients may be able to modify or cancel bids once the pre-auction bidding window is closed. If cancellation of a bid is required subsequent to the pre-auction bidding cut-off time, Capital Markets 107 may provide this service manually; there would be no change in the time-bucket of the aggregated bid if individual bids are cancelled or modified. The system should provide Capital Markets 107/Auctioneer 106 access to the retail brokerage bid stack to allow for individual bid modifications. This ensures that allocations calculated by the system post-auction match up to indications supplied by the dealer.

Post-auction, the system provides the functionality to redistribute price-point-aggregated bid awards across all individual bids collected during pre-auction bidding. Once allocations have been distributed across accounts, the system provides the final allocation data, at the account level, in the form of an on-screen report. The system provides a mechanism through which the underwriter's IT Operations 112 can generate clearing data for each auction by dealer in a pre-defined flat file and a CSV file.

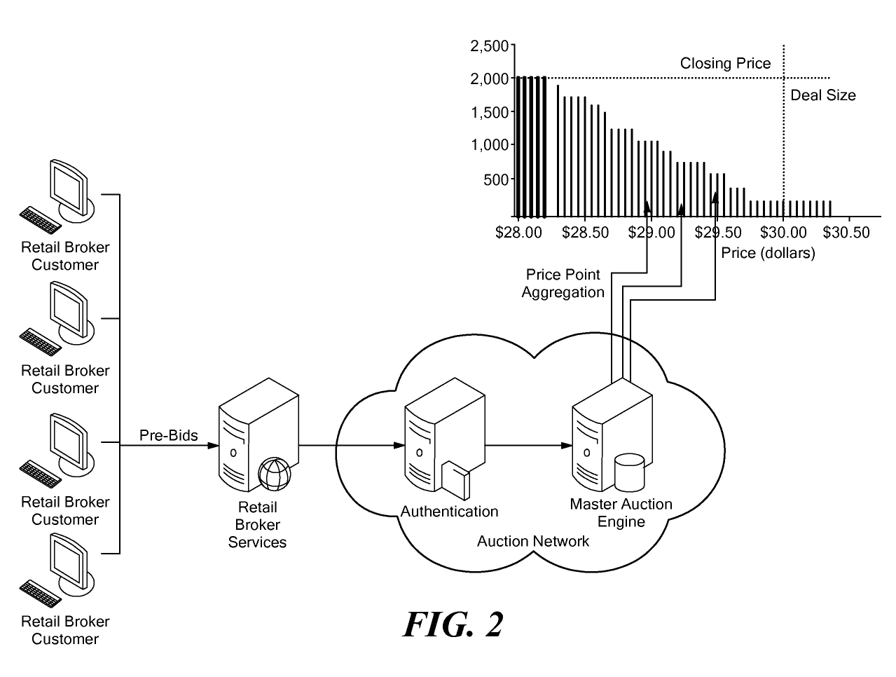

An example of the price point aggregation is shown in FIG. 2 as follows:
10 retail broker customers pre-bid for 120 shares at 29.00
2 retail broker customers bid for 400 shares at $29.25
10 retail broker customers bid for 60 shares at $29.50
   Therefore there are a total of 22 unique retail broker customers participating; these bids will be aggregated into the following and displayed in the bid stack as:
A bid from retail broker for 1200 shares at $29.00
A bid from retail broker for 800 shares at $29.25
A bid from retail broker for 600 shares at $29.50

Lower Volume, Small Regional Retail Dealers. Smaller regional retail dealers, including the underwriter brokerage, may be subject to the same pre-auction bidding rules as the electronic retail brokerages. Because the volume of bids is lower and manageable one-by-one, the auction platform may offer a dealer bid management interface which may allow these bids to be entered manually by the dealer. Retail dealer bids may also be aggregated at price points by the system prior to entry into the auction engine.

Post-auction, the system provides functionality to redistribute price-point-aggregated bid awards across all individual bids collected during pre-auction bidding. Once allocations have been distributed across accounts, the system provides the final allocation data, at the account level, in the form of an on-screen report. The system also provides a mechanism through which IT Operations 112 can generate clearing data by dealer for each auction in a pre-defined flat file and a CSV file.

Institutional Investors. Institutional clients may create the majority of the volume throughout the auction, and fall into two categories. Institutional clients of the underwriter may access the auction via the underwriter web bidding interface. They may enter in pre-auction bids using Capital Markets 107. Bidding account credentials may be controlled by the underwriter and passed to each client. Once allocations have been distributed across accounts, the system provides the final allocation data at the account level in the form of an on-screen report. The system also provides a mechanism through which IT Operations 112 can generate clearing data by dealer for each auction in a pre-defined flat file and a CSV file. Institutional dealers and co-managers have the ability to create bidding accounts for their clients, and they are responsible for assigning purchase limits, disseminating user IDs and passwords, and therefore have full responsibility for bids created in the auction by these accounts. For the purposes of the auction, institutional dealers and co-managers may be treated as equivalent.

For each auction, the institutional dealers and co-managers may be given a maximum aggregate purchase limit. If a maximum purchase limit is imposed, the sum of the purchase limits they assign each bidding account created by the dealer cannot exceed dealer maximum purchase limit. These dealers may then have the ability to create pre-auction bids on behalf of these accounts, subject to each account's purchase limit. The investors for whom the dealer created the accounts can participate in the live auction using the dealer-provided user IDs and passwords through the auction web channel.

The system allows Capital Markets 107/Auctioneer 106 to create sales/trading and sales management user accounts for representatives of co-managers/institutional dealers. Once allocations have been distributed across accounts, the system provides the final allocation data at the account level in the form of an on-screen report. The system also provides a mechanism through which IT Operations 112 can generate clearing data by dealer for each auction in a pre-defined flat file and a CSV file. The institutional dealers and co-managers firm code is captured by Trading Operations 111 in the Dealer ID field, which facilitates the clearing and settlement process for Trading Operations 111.

A co-branded web interface, or skin, may be used by some partner electronic dealers. This involves providing a different graphic frame/border, perhaps with both the underwriter logo and co-manager logo. The system may leverage URL parameters to determine which skin is displayed to investors in the auction bidding interface and in the dealer interface.

Auction monitors are users who have read-only access to the transparency data in an auction. Monitors cannot bid in auctions; they can only watch. They can see only the basic transparency data and history of their firms past auction performance if their account ID is recognized. Examples of monitors are issuer representatives, members of the media, and board members.

Participation from backstop bidders may only take place prior to the auction start, during the backstop price agreement with the underwriter. Backstop bidders may not be able to participate in the auction except as a monitor. Backstop bids may be entered into the auction platform by the Auctioneer 106. The auction system should accommodate multiple backstop bids, potentially at different price points.

Pre-auction bids can be submitted prior to the auction start during the pre-auction bidding period defined by the Auctioneer 106. Pre-auction bids may then be assigned a first time bucket timestamp once the auction commences. Pre-auction bids are expressed in the form of a limit bid.

Investors with live-auction bidding accounts can bid during the auction open period. Once a user creates a bid, a second notification is returned to confirm the bid details. Messages may include entry errors, bid/auction constraint errors, or warning messages. Upon acceptance and positive confirmation, the bid is sent to the Master Auction Engine 103 and only then is a time stamp generated and the bid assigned into a time bucket. From this point the user has the following options:
Increase or decrease the bid price, creating a new time-stamp.
Decrease the bid size, creating a new time-stamp.
Increase the bid size by less than or equal to 50% (a per auction variable) of the starting size, time-stamp remains the same.
Increase the bid size by more than 50% (a per auction variable) of the starting size, creating a new time-stamp.
Cancel the bid.

The submitted bid should be greater than or equal to the minimum bid size and less than the maximum bid size for either the auction default rules or investor-specific rules. The transparency data containing the pre-auction bids and bids entered in the first time-bucket may not be displayed until the second time-bucket.

The competitive (limit) bid consists of both a quantity and a price. Each authorized bidding account may have the ability to enter a single competitive limit bid. The bidding increment may be a system parameter which is defined as part of the auction terms, for example 1 cent, 5 cents, 10 cents, 25 cents. When viewing the bid stack, the investor should be able to identify his own bid among the anonymously presented bid data.

The transparency data may be published to the Qualified Bidding Gateways 105 as a multiple of the time bucket. Each investor participating in or viewing the auction may have access to the auction histogram and bid stack that synchronously updates inline with the Qualified Bidding Gateways 105. The bid stack may display the price and quantity of each bid, but not the investors' account details. The bid stack table may consist of [price, time-stamp, quantity, cumulative quantity] The transparency data may also include the current clearing price, if any. The transparency data may or may not contain the backstop bids. If it does not, the clearing price calculation may not take into account the backstop bids. If backstop bids are displayed in the transparency data, then the clearing price calculation may include the backstop bids.

The purchase limit defines the maximum bid size any investor can place in an auction; this parameter may be identified as a share amount. The purchase limit may be assigned by Capital Markets 107 for the underwriter clients, and by dealers for their customers. The purchase limit may be a share quantity derived from the tier limits defined in the auction terms. Each account is assigned a tier during account setup. The system may use the auction tier limit definition and the customer's assigned tier to set default share purchase limits for each customer in each auction. If an account wishes to buy more than their current purchase limit allows, they should call Sales and Trading 109 before or during the auction. Sales and Trading 109 may relay the request to Capital Markets 107 who may discuss the request with the issuer. If the issuer and Capital Markets 107/Auctioneer 106 agree to raise an account's purchase limit, the system allows Capital Markets 107/Auctioneer 106 to update the user's account. Therefore, the system offers Capital Markets 107/Auctioneering 106 the capability to increase an investor's purchase limit on-the-fly during an auction, without limitation by any existing bid size constraint in the system.

A user may have access to the allocation history of their firm, regardless of whether their rights allow them to bid on the auction or just monitor. Only one user from each firm can bid on an auction, therefore there may be multiple client users with view-only access. The allocation history may display one of the following for each auction the account has permission to access:
Your bid was not successful.
Your bid resulted in an allocation of: [allocation size, price]

The rule set is a plain-text document that contains the rules of engagement for each auction. The rule set can be uploaded from within the administrative interface by the Auctioneer 106.

The deal terms which govern the auction parameters may be as follows:

| Term | Description |
|---|---|
| Issuer | Issuer Company Name |
| Auction Date/Time | Date and Time of auction (displayed outside the auction) - |
| | this should be a text field |
| Auction Open Time | Time the auction opens for live-auction bidding |
| Auction Close Time | Time the auction closes for live-auction bidding |
| Pre-Auction Bidding Open | Time at which the pre-auction bidding window opens |
| Pre-Auction Bidding Cut- | Time at which the pre-auction bidding window closes |
| Off | |
| Deal Size | The number of shares offered. |
| | This can be changed by the Auctioneer during the |
| | auction. |
| Trade Date | Trade Date for this transaction |
| Settlement Date | Settlement date for this transaction. |
| Mkt. Close on Auction Date | Stock closing price on the day of the auction. |
| Minimum Price | The lowest bid price allowed during an auction. Will be set |
| | as zero by default. |
| Maximum Price (if any) | The highest bid price allowed during an auction. |
| High Price Warning | Bids above this price may receive a warning from the system |
| | to double-check their bid price for errors. The system |
| | should allow Capital Markets to disable this feature (perhaps |
| | by entering zero as the price value). |
| Price Increment | The increment of permitted bid prices allowed during an |
| | auction. (divisible into or multiple of 1.00) |
| Auction Purchase Limit | The default maximum purchase amount for each account |
| Tiers | tier |
| Minimum Bid Size | The minimum number of shares that an investor may bid |
| | in an auction. |
| Maximum Bid Size | The maximum number of shares that an investor may bid |
| | in an auction. |
| Increment Bid Size | The increment of permitted bid sizes allowed during an |
| | auction. |
| Lead Manager(s) | Manager(s) behind auction |
| Lead Manager Role | Label (Role description, i.e. “Lead Manager”) to describe/ |
| | precede Lead Manager value |
| Co-Manager(s) | Any co-managers |
| Co-Manager Role | Label (Role description, i.e. “Co-Managers”) to describe/ |
| | precede Co-Manager(s) value |

Many auction terms are captured purely for display purposes only, while other auction terms are variables that affect or govern the mechanical operation of the auction itself. The auction term sheet displayed to investors in the auction evolves chronologically with the auction. The system may allow Capital Markets 107/Auctioneer 106 to mask the value of certain auction variables during some, but not all, auction states. The following table give examples of which variables may be maskable, and during which auction state any mask would apply:

| | Auction State | | |
|---|---|---|---|
| | | Countdown/ | |
| | | Bidding Open/ | |
| | Pre-Bidding | Bidding | |
| | Open | Closed/ | |
| | Pre-Bidding | Allocation | |
| Terms | Closed | Review | Completed |
| Issuer | D | D | D |
| Deal Size | O | D | D |
| Lead Manager | D | D | D |
| Co-Manager | D | D | D |
| Bid Price Increment | O | D | ND |
| Min/Max Bid Price | O | D | ND |
| Auction Max Purchase Limit | O | D | ND |
| Bid Size (Min/Max/Incr) | O | D | ND |
| Trade Date | ND | ND | D |
| Settlement Date | ND | ND | D |
| Closing Price on Auction Date | D | ND | D |
| Company/Deal Description | D | D | D |
| Auction Clearing Price | ND | ND | D |

D—Displayed
O—Override/Masking Capability
ND—Not Displayed
VL—Variable Label

Calculation of the clearing price requires arranging bids from the highest to the lowest price, and within each price point in time-bucket order. In this order, the bids may be accepted (fully allocated) starting with the highest bid based on the price in each bid until the aggregate number of shares allocated is greater than or equal to the deal size. Bids at the clearing price may be fully allocated in time-bucket order until stock is no longer available. The highest limit price level that results in the total quantity of shares requested being at least equal to the deal size is called the “clearing price.” The “clearing bid” is defined as the winning bid with the last time-bucket for which stock is available. If multiple “clearing bids” exist, these bids may be allocated all remaining shares on a pro-rata basis. Any backstop bids may be included in the clearing price calculation following the auction close. Whether backstop bids are included in the clearing price during the auction is determined by Capital Markets 107/Auctioneer 106 prior to the auction start.

A backstop bid is an agreement between one or more capital partners or a co-managing underwriter on the one hand, and the lead underwriter/auctioneer or issuer on the other hand to buy some of or all outstanding shares in the auction at a set price or prices, or is a purchase of one or more put options by the underwriters in the auction. Backstop bids can be confirmed before or after the market close on the same day as the auction, but prior to the auction start.

The system may offer Capital Markets 107/Auctioneer 106 the choice of displaying the backstop bids to investors. If Capital Markets 107/Auctioneer 106 elects to display the backstop bids to investors in the auction, the backstop quantities and prices may be displayed for all investors as part of the base auction transparency data. The backstop bids may appear in the transparency data's histograms as any other limit bids would. In the anonymous bid data table, however, backstop bids may appear without a timestamp. If the backstop bid is not displayed to investors in the auction, the existence of the backstop bids may be entirely concealed to investors during live-auction bidding. The displayed clearing price may therefore be computed without reference to the backstop bid.

Backstop bids may not receive a time-bucket in the auction. For allocation purposes, the backstop bid time-bucket is equal to the time-bucket following the latest time bucket possible during the live auction. Therefore, the back-stop bidders may not receive any shares if the auction clearing price is higher than the back-stop price. If the auction clearing price is equal to the backstop price, then the back-stop bidders may receive only the shares that remain after all investors who bid at or above the clearing price are fully allocated. If backstop bids with prices above the clearing price exist at the close of the auction, these bids may be treated as having prices equal to the clearing price for the purposes of allocation. This ensures that any backstop bids that are awarded an allocation receive that allocation only after all other investors are allocated shares, regardless of the backstop bid prices. This also ensures that all winning backstop bids are treated equally with respect to one another.

If the aggregate number of shares above the clearing price is greater than the deal size, then either:
Shares are awarded to exactly meet the deal size. If there is more than one clearing bid with the same time stamp, these accounts may receive a pro-rata allocation.
Shares may be awarded in an amount greater than the deal size; this may result in the underwriter taking on a short position to fill the remaining balance. The Auctioneer 106 may be responsible for taking the necessary action.
Allocations can be changed after the auction is closed by users with the proper entitlement. Other participant allocations would not be affected.

The Master Auction Engine 103 uses the following data as inputs:
The auction bid stack
The total available shares to allocate (default is the deal size)
   Bids are fully allocated shares from the highest price to lowest, and within price by time-bucket (earliest to latest). Bids are allocated shares from the top down until the supply of shares (the total available) is exhausted. If a tie in time-bucket exists at the “clearing bid,” all remaining shares are awarded pro-rata to these bids.

Capital Markets 107 can eject users from an auction if they are deemed manipulative or disruptive to the auction. If so, the user may see the message:

“Your session has ended, please contact your Sales Person”

This message is configurable (globally) in the system by IT Operations 112.

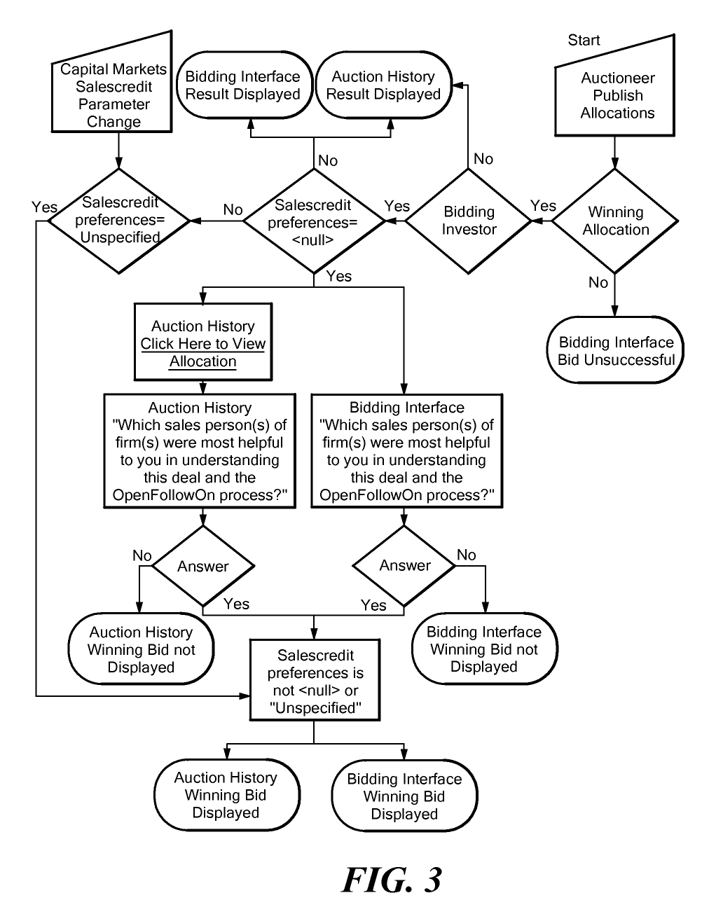

FIG. 3 illustrates an example of the post-auction sales credit preference process. Prior to viewing an allocation in the auction bidding interface, an investor with a successful bid should be presented with a screen prompting him to enter a sales credit preference. The default setting for the prompt may be a question asking the investor, “Which sales person(s) or firms(s) were most helpful to you in understanding this deal and the auction process? Please type your brief response in the text field below.” The prompt question itself can also be customized by the Auctioneer 106 in the auction set-up screen. The input style for the investor's required response as to sales credit preference may be a free-form text field (100 characters max). When allocations are published, all investors who are awarded an allocation may have the sales credit preferences set to a “null” value. Subsequently, the investor with a successful bid should indicate something in the free-form text field in order to view his allocation in the bidding interface. Investors who do not receive an allocation may be so notified, without the intermediate sales credit preference step. Also, in the auction history, where allocations would normally be displayed post-auction, if an investor's sales credit preference is “null” for an auction, the system should present a “Click Here to View Allocation” link in place of the allocation itself. This may direct the investor into the bidding interface for that auction, where the investor may be prompted for sales credit preference. Once the investor has indicated his sales credit preference either in the bidding interface or via the auction history link, the allocation may thereafter be displayed in the bidding interface and auction history screens as normal.

Finally, the system should also provide a facility in the auctioneer interface for Capital Markets 107/Auctioneer 106 operations to populate the sales credit field with a non-null value (such as “Unspecified”) after the auction is complete, so that investors can immediately view their allocations without the intermediate step of indicating a sales credit preference. Typically, after settlement for the deal is complete, it is no longer necessary to collect sales credit preferences from investors. To facilitate the tracking of sales credit, the investor's response should be shown to Capital Markets 107 and Trading Operations 111 as part of the clearing report.

The Auctioneer 106 may have the capability to specify (before the auction) the range of bids that are displayed by the histogram. He may also have the capability to modify (during the auction) the displayed range. In the Auction Setup parameters, the Auctioneer 106 may have the ability to specify and subsequently modify:
Minimum displayed bid price
Maximum displayed bid price.

The System may calculate the increments displayed based on a formula which takes into account the difference between the min and max displayed bid prices, and the permitted bid increments. In no case may the system display increments which are more precise than permitted bid increments as specified in the terms of the auction.
If the difference between min and max displayed bid price is less than 50 cents: display increments may be 0.01 s.
If the difference is between 50 cents and 2 dollars: display increments may be 0.05 s.
If the difference is between 2 dollars and 5 dollars: display increments may be 0.10 s.
If the difference is between 5 dollars and 10 dollars: display increments may be 0.25 s.
If the difference exceeds 10 dollars, the display increments may be 0.50.
   The histogram may display increments which are less precise than are specified as permitted bid increments in the terms of the auction.

The display should have the capability of “rounding” and “truncating.” For example, if display increments of 0.10 are chosen and allowable bid increments are 0.05 s, then bids of (0.05, 0.15, 0.25) would be “rounded” to the next lowest bar on the chart (0.00, 0.10, 0.20). If a displayrange of $8 to $10 is chosen, bids which are less than $8 may be “truncated” and shown as “<or =$8” and bids which are greater than $10 may be truncated and shown as “>or =$10.” The tabular data on the investors bidding interface may not perform any rounding or truncating and may show the exact data as investors have entered it.

Specific variables may be defined within the auction platform when a given auction is created in the system. One such variable is for transparency interval. Measured in seconds, this variable defines how frequently new auction transparency information is made available to potential purchasers. Specific embodiments update the transparency information to all potential purchasers only as frequently as every [Transparency Interval] seconds. Reducing the transparency interval causes the system to provide updated transparency information more frequently.

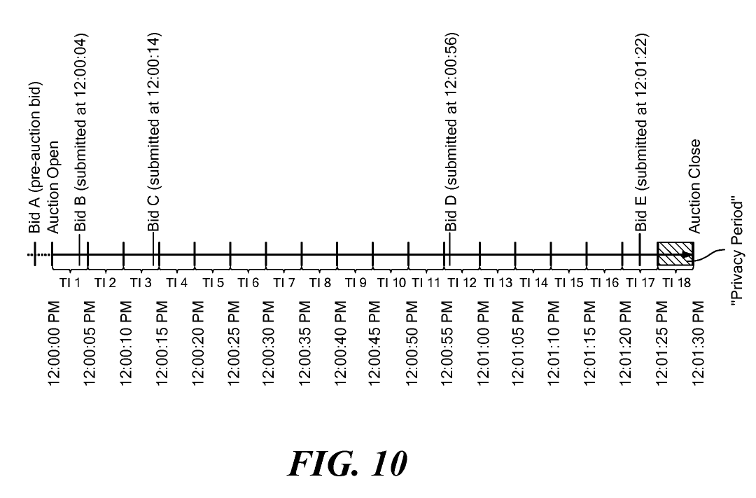

FIG. 10 illustrates the concept of how a transparency interval variable can be used in an auction. In the given example, a 5 second transparency interval is used. As shown in the illustrated timeline and summarized in the following Bid Data Table, pre-auction Bid A is received and entered before the start of the auction. When the auction starts at 12:00:00 PM, the first transparency interval, TI 1 begins, and the public bid data associated with Bid A is made available to the other potential purchasers. At 12:00:04 PM, Bid B is received. Since this occurs during TI 1, the bid will not show to the other participants in the auction until the end of TI 1/beginning of TI 2 at 12:00:05 PM. Similarly, Bid C is submitted during TI 3 at 12:00:14, and won't be visible to the rest of the auction until the beginning of TI 4 at 12:00:15 PM. Bid D is submitted just after the beginning of TI 12 at 12:00:56 PM and won't be visible to the rest of the auction until the beginning of TI 13 at 12:01:00 PM, and so on.

Bid Data Table

During TI 1: 1 Bid as of 12:00:00 PM
During TI 2: 2 Bids as of 12:00:05 PM
During TI 3: 2 Bids as of 12:00:10 PM
During TI 4: 3 Bids as of 12:00:15 PM
. . .
During TI 10: 3 Bids as of 12:00:45 PM
. . .
During TI 12: 3 Bids as of 12:00:55 PM
During TI 13: 4 Bids as of 12:01:00 PM
. . .
During TI 18: 5 Bids as of 12:01:25 PM
Post-Closed: 5 Bids as of 12:01:30 PM¹
¹Not displayed (auction has closed)

A privacy period is defined at the end of the auction after the last transparency interval TI 18 begins at 12:01:25 PM until the auction close time at 12:01:30 PM. The privacy period is a period of time during which the auction is receiving and accepting bids, but no further transparency updates will be displayed to investors. Therefore, a bid placed during an auction's privacy period is effectively hidden with respect to the other potential purchasers for the remainder of the auction.

Basically, the transparency interval affects how frequently new auction public bid data will be made available to potential purchasers. Transparency information displayed at any given time will only contain bid data captured by the system as of the end of the last transparency interval. Because the last transparency interval ends at maximum one interval prior to the close of the auction, no bid data received by the system after that will be reflected back to investors. Therefore, the auction's length, and the size of the transparency interval are all determinants of the size of the privacy period at the end of the auction.

Another related variable that may be defined is referred to as time bucket size. Measured in seconds, the time bucket size variable defines the size of timestamp equivalency buckets, which may be explained as follows. Potential purchasers may place bids at any time during an auction. At the time a bid is received, it is assigned to a current timestamp equivalency bucket with the first timestamp equivalency bucket beginning at the auction start time. The first timestamp equivalency bucket ends [Time Bucket Size] seconds later, at which time the second timestamp equivalency bucket begins.

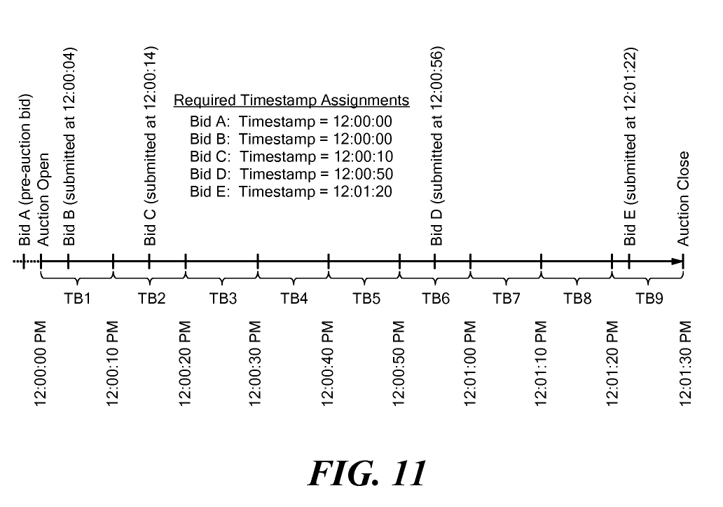

FIG. 11 illustrates the concept of time buckets and timestamps using the same bid timing examples given in FIG. 10, but showing time buckets of 10 seconds in length. In this embodiment, the time stamp equivalency buckets are referred to by their start time. All bids placed within the same timestamp equivalency bucket are equalized with respect to timestamp regardless of the exact time the bid was actually received by the system. So the timestamp displayed in the auction interface is actually the name of the timestamp equivalency bucket, not the actual time at which the bid was received. Bid A was submitted to the system before the beginning of the auction and is given a timestamp assignment of the auction start time, 12:00:00 PM. Bid B was submitted to the auction at 12:00:04 PM, which is within the first time bucket, TB 1, so it is given a timestamp assignment like Bid A of 12:00:00 PM, the beginning of TB 1. Thus, the auction system treats Bid A and Bid B as if they were received at the same time. Bid C is submitted to the system at 12:00:15 PM during TB 2, so it receives the start time of TB 2 as its timestamp, 12:00:10 PM, and Bid D and Bid E are treated similarly.

The auction securities allocations are divided pro rata among all marginal bids (bids which are tied at both the clearing price and timestamp and are last in line for any remaining stock). So increasing the time bucket size provides a mechanism to increase the number of marginal bids, thereby potentially widening the distribution of securities in an offering.

The timestamp assigned to a bid is the earlier of the two time bucket boundaries between which the bid is placed. Therefore the first valid time bucket generally is labeled with the auction open time, and the last valid time bucket is labeled with a timestamp equal to one time bucket prior to the auction close time. But there are some exceptions. For pre-auction bids, the timestamp assigned is equivalent to the timestamp assigned to bids entered within the first time bucket. For backstop bids, the timestamp assigned (not displayed) is equivalent to the hypothetical timestamp that would be applied to a bid received during the time bucket immediately following the last available time bucket in the offering.

Time bucket size and transparency interval can be treated as independent variables, but in some specific embodiments it may make sense only for the time bucket size to be equal to or a multiple of the transparency interval.

The following entitlements have been created to capture the roles and responsibilities of the internal underwriter users and external partner users. Because internal roles and responsibilities shift within the underwriter from time to time, the system entitlement structure should be flexible enough to capture an expansion or contraction any particular role by allowing an administrator to add or remove entitlements from any user account. The various entitlements follow:

| | Internal Business Units | | | | | | External Users | | | | | |
|---|---|---|---|---|---|---|---|---|---|---|---|---|
| | IT Op's & | | Capital | Sales & | Trading | Sales | Institutional | | | | Sales | Sales & |
| Entitlement | Admin | Auctioneer | Markets | Trading | Op's | Mgmt | Investor | Dealer | Monitor | Issuer | Mgmt | Trading |
| Investor | | | | | | | X | | | | | |
| Allocation | | | | | | | | | | | | |
| View | | | | | | | | | | | | |
| Anonymous | X | X | X | X | X | X | X | X | X | X | X | X |
| View only | | | | | | | | | | | | |
| Full Data | X | X | X | | TBD | | | | | X | | |
| View Only | | | | | | | | | | | | |
| Account | X | TBD | TBD | | X | | | X | | | | |
| Creation | | | | | | | | | | | | |
| Mgmt | | | | | | | | | | | | |
| Account | | X | X | X | X | X | | X | | | X | X |
| View | | | | | | | | | | | | |
| Investor Bid | | | | | | | X | | | | | |
| Mgmt | | | | | | | | | | | | |
| On-Behalf- | X | X | X | | TBD | | | | | | | |
| Of Bid | | | | | | | | | | | | |
| Mgmt | | | | | | | | | | | | |
| Admin Bid | X | TBD | | | | | | | | | | |
| Mgmt | | | | | | | | | | | | |
| Auction | X | X | | | | | | | | | | |
| Mgmt | | | | | | | | | | | | |
| Allocation | X | X | | | X | | | | | | | |
| Mgmt | | | | | | | | | | | | |
| Allocation | X | X | X | | X | X | | X | | X | X | |
| View | | | | | | | | | | | | |
| Participation | X | X | X | | X | X | | | | | | |
| View | | | | | | | | | | | | |
| Participation | X | X | X | | | | | X | | | | |
| Admin | | | | | | | | | | | | |
| Institutional | | | | | | | X | | | | | |
| Account | | | | | | | | | | | | |
| Mgmt | | | | | | | | | | | | |
| Dealer Bid | | | | | | | | X | | | | |
| Mgmt | | | | | | | | | | | | |
| Dealer Bid | X | | | | | | | | | | | |
| Mgmt | | | | | | | | | | | | |
| Admin | | | | | | | | | | | | |

Entitlement categories are as follows:

| Entitlement | Action(s) |
|---|---|
| Investor Allocation View | Final allocation and price view per client. |
| Anonymous View Only | Display of auction bid data with no client names. |
| Full Data View Only | Display of auction bid data with names. |
| Account Creation Mgmt | Ability to create, delete and mark accounts as inactive. |
| | Ability to change any account parameters. |
| | NB: If an account has bid history, it cannot be deleted. |
| Account Creation View | Read only access of client account information. |
| Investor Bid Mgmt | Ability to create, modify and cancel bids for the client the user is |
| | representing. |
| | Subject to normal bid creation and modification time-stamp rules. |
| | Cannot enter pre-bids. |
| On-Behalf-Of Bid Mgmt | Ability to create, modify and cancel bids for the any |
| | Investor participating in the auction. |
| | Ability to enter pre-bids. |
| | Cannot enter in the back-stop bid. |
| | No time-stamp administrative access. |
| Admin Bid Mgmt | Artificial bid creation for any participant. |
| | No restriction on bid size or time (before, during or after the auction). |
| | Ability to assign any time-stamp to the bid. |
| Auction Mgmt | Auction creation. |
| | Upload, modify, delete Rule-set. |
| | Upload, modify, delete auction terms |
| | Upload, delete prospectus and company logo. |
| | Control over auction start, end and extension. |
| | Change auction state to publish allocations to investors after allocation |
| | finalization. |
| Allocation Mgmt | Create, delete and modify allocations. |
| Allocation View | Read only access of allocation information. |
| Participation View | Ability to see logged in users. |
| | Ability to see who has agreed to the participation agreement. |
| Participation Admin | Ability to eject a user from the auction. |
| | Ability to change a user's Purchase Limit. |
| | Ability to send broadcast messages. |
| Institutional Account | Creation of bidding accounts for their clients |
| Mgmt | Assigning purchase limits (which cannot exceed the total of the |
| | investors total purchase limit). |
| Dealer Bid Mgmt | Ability to enter a bid though a partner channel. |
| Dealer Bid Mgmt Admin | Ability to view and edit all dealer bids. |
| Entitlement Admin | Ability to set-up users within the auction software and grant entitlement |
| | rights. |

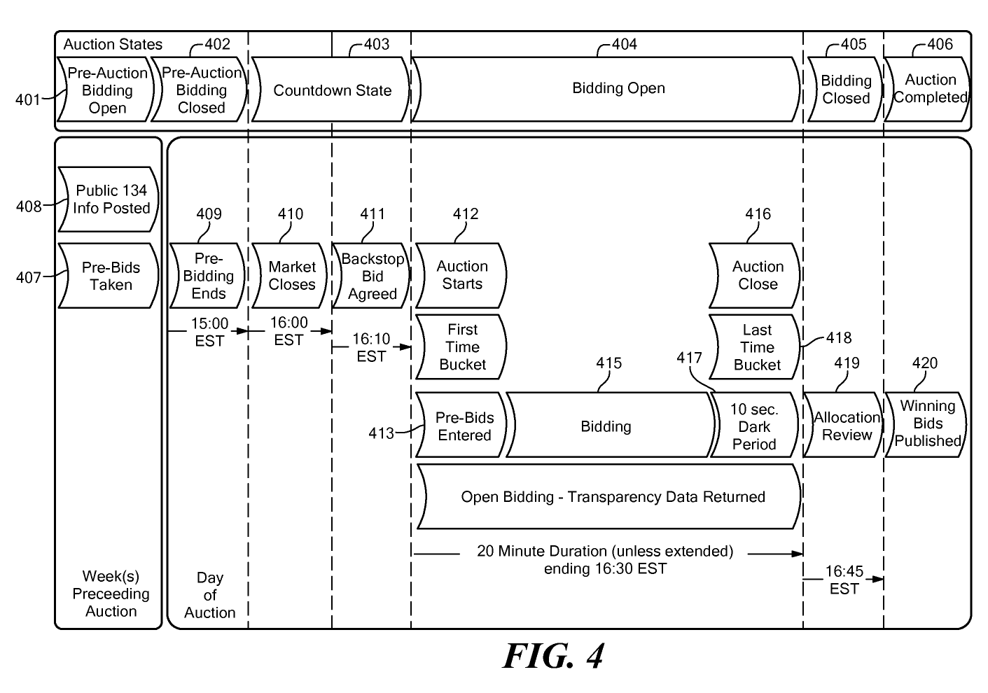

FIG. 4 illustrates the timeline for an auction according to one specific embodiment. As shown across the top of FIG. 4, the auction process follows a sequence of literal auction states 401-406. External users of the system may be presented with a functional equivalent to the literal states (described below). While some state changes are automatic (governed by the system clock), all state changes can be controlled by the Auctioneer 106 with the bidding interface management screen. State changes for which no time is specified may require the Auctioneer 106/Capital Markets 107 to manually shift the auction to the next state.

Once the auction has been created and has been approved for public viewing, the auction may be in an announced Pre-Auction Bidding Open State 401 where pre-auction bids may be accepted. The ending of the acceptance of pre-bids is defined in the auction terms. The move to the next state may be automated, but can be extended or reversed by Capital Markets 107/Auctioneer 106.

In the Pre-Auction Bidding Closed State 402, pre-auction bidding is no longer allowed. The auction terms are finalized during this state and the countdown state may not start until the Auctioneer 106 determines that set-up has been finalized.

The next move to the Countdown State 403 may be manually shifted by Capital Markets 107/Auctioneer 106. The auction may not move into the Countdown State 403 until full auction terms, prospectus and rule set information has been loaded, approved and a time is set. This may be a countdown timer to the next state and the change may be automatic, unless interfered with by the Auctioneer 106 who can pause or change the time (increase or decrease) and manually effect the state change.

In the Bidding Open State 404, the auction is now open for bidding. The length of the auction may be dictated by a countdown timer; again the Auctioneer 106 can pause or change the time (increase or decrease) and manually effect the state change to closed. In the next Bidding Closed State 405, the auction closed for bidding and the user may see a message communicating the same and to wait for results. The winning allocations may be reviewed internally by the underwriter and adjusted if need be, by users with allowable entitlements. Before the allocations are published, they are reviewed and confirmed. Once the secondary and final allocation review has taken place; the state change to publish the results is manual. Capital Markets 107/Auctioneer 106 can decide whether to include final transparency data along with award announcement by selecting the appropriate next state.

The Auction Completed State 406 indicates that bidders can see their final allocation. The system displays only the bidder's result and the clearing price of the auction. Capital Markets 107/Auctioneer 106 can elect to display final auction transparency data. In this instance, all final auction transparency data may be displayed, including the backstop bids.

An Auction Cancelled State (not shown) indicates an auction previously in any other state has been officially cancelled. Any movement to this state may always be manual.

Functional auction states may be communicated to external users in place of the literal auction states. The mapping of these states is as follows:

| [Literal State Name] | [Functional State Name] |
|---|---|
| Pre-Auction Bidding Open | Not Open |
| Pre-Auction Bidding Closed | Not Open |
| Countdown | Not Open |
| Open | Open |
| Closed | Closed |
| Completed | Completed |
| Cancelled | Cancelled |

At some time prior to the start of the auction, the auction process starts in the Pre-Auction Bidding Open State 401, and pre-bids are taken, 407. In addition, the Auctioneer 106 may post the following information on the Auction site, 408, (as allowed by Rule 134 of the Securities Act of 1933, as amended):
The deal size.
The minimum and maximum share price for which bids may be accepted. If the minimum price is 0.0, the price range may not be displayed among the deal terms. If the minimum price is greater than 0.0, the system may display the auction price range.
A minimum bid size and a maximum bid size (if any).
The approximate date and time of the auction start and finish.

On the day of the auction, the auction state changes to Pre-Auction Bidding Closed, 402 and pre-bidding ends, 409. The auction process now enters the Countdown State 403 once the market closes, 410. The market closing price for the security may then be used to determine the backstop price. Once the backstop bid is agreed 411 by the backstop bidders and the issuer or lead underwriter, the auction may start 412, and Bidding Opens 404. Any pre-auction bids are then entered 413 into the first time-bucket 414 and open bidding commences 415. The auction is estimated to last 20 minutes.

At the end of that time, unless Capital Markets 107/Auctioneer 106 elects to extend the auction, the auction closes 416 with a 10 second dark period 417 during which final bids may be entered in the last time bucket 418. The Bidding Closed State begins 405 by calculating and reviewing allocations 419 and any reallocation or deal size adjustment is made. Once any allocation adjustments are made and approved, each participant then receives their allocation result when the winning bids are published 420 and the Auction Completes 406. This is a manual step instigated by the Auctioneer 106.

Embodiments of the present invention include an allocation mechanism for follow-on auctions. Because such auctions are live and interactive, with full demand transparency, allocation algorithms provide incentives to investors who bid early and realistically. All the investors can benefit from the collective intelligence of the developing demand curve, and they can react quickly in a near-real-time price discovery process similar to the informal “price-talk” associated with today's traditionally executed transactions.

In specific embodiments, bids are filled:
100% for all bids above the clearing price;
100% for all bids at the clearing price in timestamp order, with early bids taking priority over later bids;
partially for the marginal bid, where the marginal bid is defined as the last bid price/time in the auction for which any stock can be allocated;
If tied bids exist on the margin (where stock is exhausted), the remaining stock is allocated pro-rata among the tied bids. The pro-rata calculation is:

Pro-Rata %=Total Marginal Supply/Total Marginal Demand

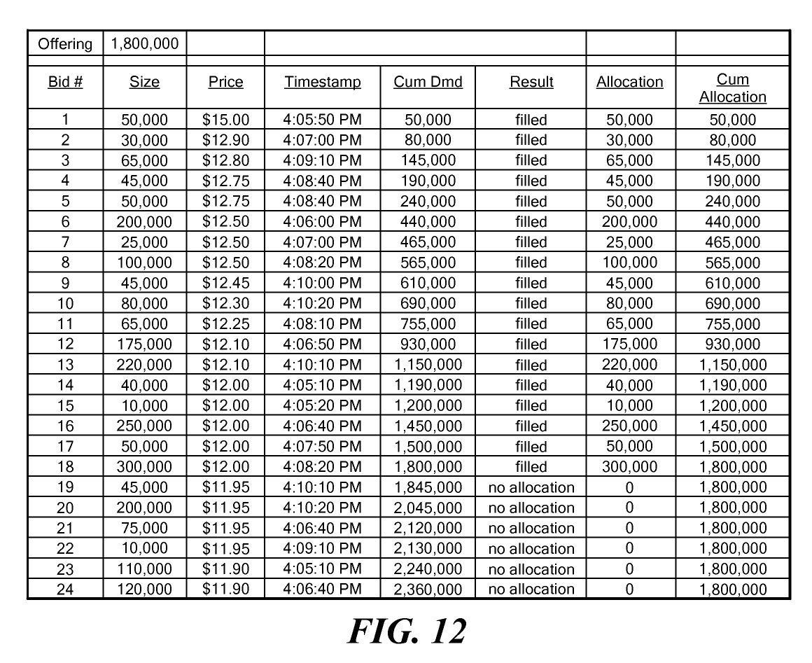

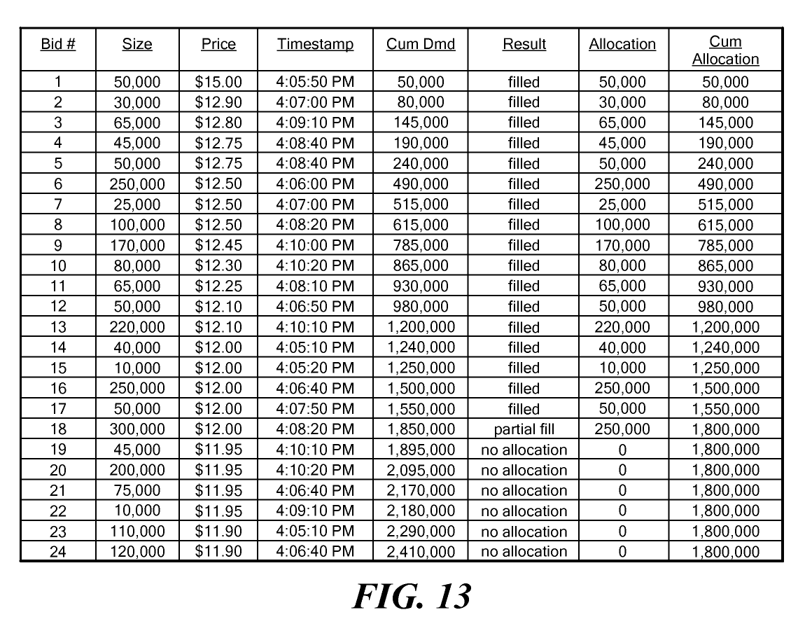

FIGS. 12 and 13 show specific examples of auctions with securities allocation according to embodiments of the present invention. In both examples, the overall securities offering is 1,800,000 shares and the final clearing price is $12.00 per share. In the example shown in FIG. 12, all 13 of the bids above the clearing price are filled at the clearing price, allocating 1,150,000 of the shares. In that example, the five bids at the clearing price are for a total of 650,000, which is the remainder of the shares offered, so that all of the bids at the clearing price are filled. In the example in FIG. 13, by contrast, the first 13 bids above the clearing price are for a total of 1,200,000 shares, all of which are filled, but only 600,000 shares remain for allocation among the five bids for 650,000 shares at the clearing price. These are filled in time stamp order with the latest bid for 300,000 shares being only partially filled for 250,000. This illustrates the rewarding of early bidders over later bidders.

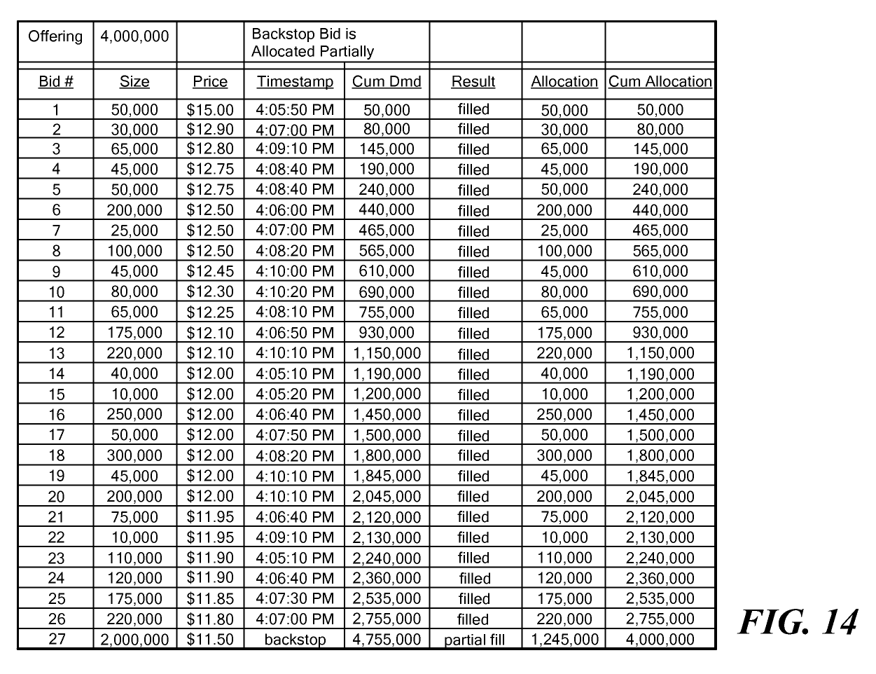

FIG. 14 shows an example of an auction with a partial allocation to a backstop bid. In the example shown, a total of 4,000,000 shares are offered, and competitive bids 1-26 allocate 2,755,000 at prices that equal or exceed the backstop bid price. That leaves an additional 1,245,000 shares that are allocated to the backstop bid of $11.50, which had committed to up to 2,000,000 shares. Thus, all of the 4,000,000 shares are allocated.

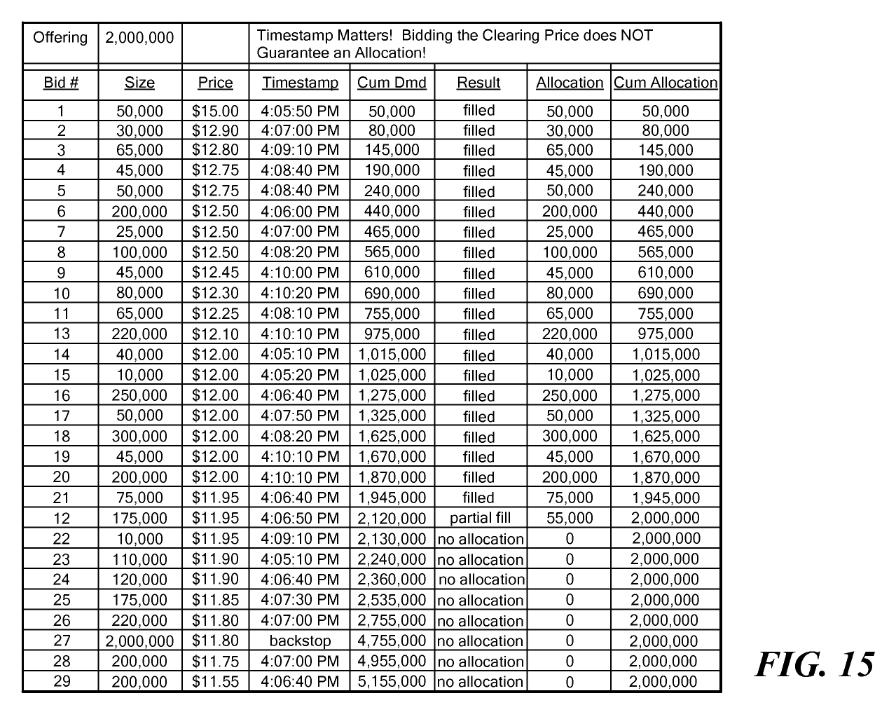

FIG. 15 shows details of an auction process illustrating that bidding the clearing price does not guarantee an allocation, but rather, that timestamp can matter. In the example shown, there are three bids at the $11.95 clearing price, but only 130,000 shares remaining to be allocated out of the original 2,000,000 share offering. Again, the marginal bids are filled in time stamp order such that the first of the clearing price bids for 75,000 shares is completely filled, the second bid at that price is only partially filled for the remaining 55,000 shares (less than the 175,000 shares desired), and the latest bid at the clearing price for 10,000 gets no allocation at all.

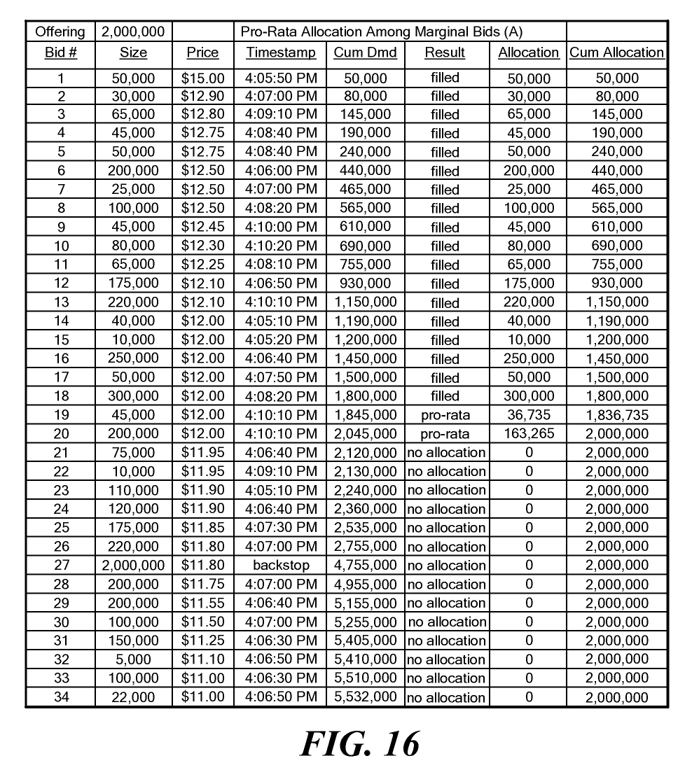

FIG. 16 shows an example of an auction according to an embodiment of the present invention in which there is a pro-rata allocation among marginal bids. In the example shown, all of the bids 1-13 above the $12.00 per share clearing price are completely filled. Out of the original 2,000,000 shares offered, that allocates 1,150,000 shares. The bids at the clearing price are initially filled in timestamp order, with bids 14-18 being the earliest bids, which are completely filled for an additional 650,000 shares. Bids 19 and 20 are both at the final clearing price and have the same timestamp. The desired total allocation for those two bids is 245,000 shares, but only 200,000 shares remain to be allocated, and again, both bids were placed at the same time for the same amount. In such a situation, these marginal bids are filled on a pro rata basis, with each bidder receiving a percentage of the shares remaining based on the earlier formula of:

Pro-Rata %=Total Marginal Supply/Total Marginal Demand.

Thus, in the example shown in FIG. 16, the remaining shares are allocated in a ratio of 36,735 shares to the smaller bid and 163,265 shares to the larger bid.

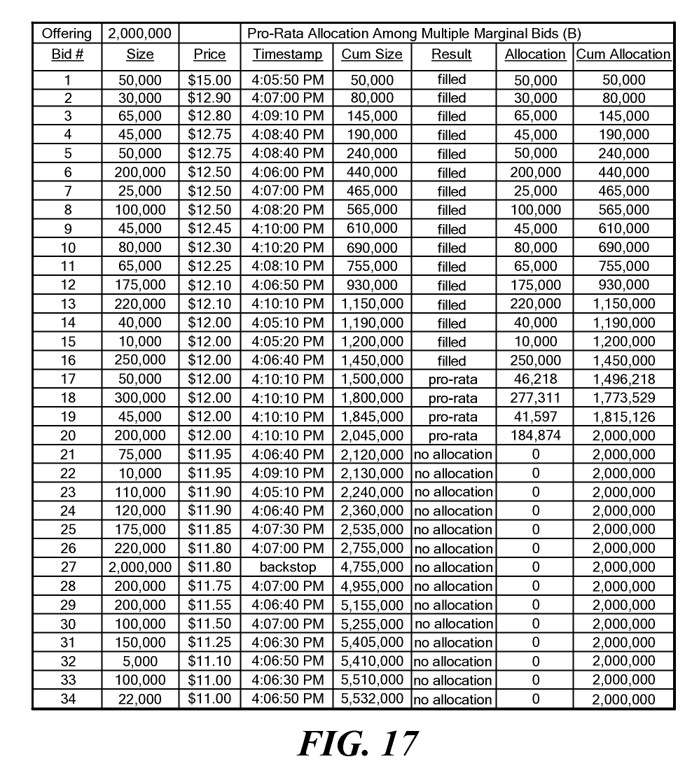

FIG. 17 shows an example similar to the situation in FIG. 16 with multiple marginal bids. In the sample shown, bids 17-20 all are at the clearing price and all have the same timestamp. Thus, those four bids receive pro rata allocations of the remaining 550,000 shares based on their respective bid sizes.

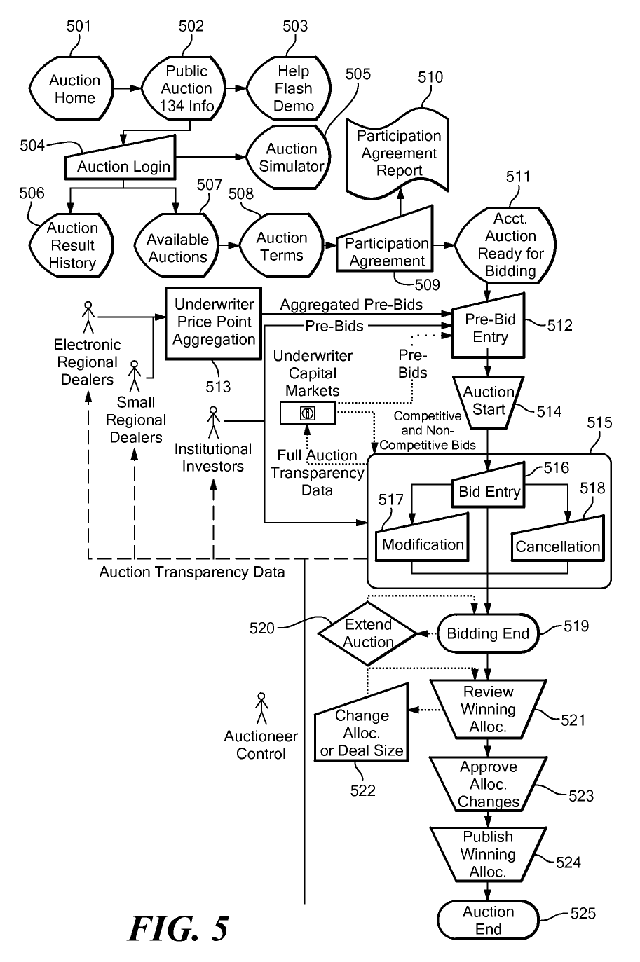

FIG. 5 shows the auction process flow according to another embodiment of the present invention. Initially, at the auction home page 501, a help flash demo 503 is available for users new to the system, and Rule 134-type auction information is offered 502. Each Rule 134-style page may contain a link to log into the auction platform to provide direct access to the bidding interface for that auction. These Rule 134-style pages may be generated dynamically by the system using auction variables and the state of the auction, in the same way the auction terms pages are generated. The auction system displays Rule 134-style transaction announcement information on public-facing “homepages” (outside the authentication mechanism). These pages are “Current Auctions” (the main page), and “Past Auctions.” Auction display categories may define the layout and location of transaction information in public-facing pages.

After logging in to the auction system 504, a screen of available current auctions 507 and another screen of past auction result histories 508 are made available. An auction's display category is used by the system to determine on which of these two screens auction information appears, and the style in which each appears. The display mode of an auction is separate and agnostic to the auction's state. Whether an auction appears on either screen (or neither) depends on its auction state and whether its display category is set to hidden.

Auction display categories govern how (or whether) an auction is made visible to investors outside the system's authentication mechanism. With the exception of the “Hidden” category, display categories don't govern the presentation of any screens within logged-in area of the system itself. The system may display hidden auctions neither pre-login nor post-login to the auction platform. Only administrators (Capital Markets 107/Auctioneer 106) with the proper entitlement may be able to see auctions whose display mode is set to Hidden. This is the default display mode for newly created auctions.

The system should display 134-style materials of highlighted auctions in a prominent fashion on the current auctions page 507. Non-highlighted current auctions may have some 134-style materials displayed, but less prominently than highlighted auctions. The system can also display 134-style materials of past auctions on the past auction result histories page 508.

An auction simulator 505 also may be accessible once the user has logged in, but it may not be accessible from the public site. The auction simulator 505 may have a different color scheme as well as a regular warning or alert that the user is participating in a simulation and not a live auction. The simulated auction may be for a fictitious company, Acme Inc, and the auction terms may be available as a pop-up window on the auction simulator 505. The system may offer users the same workflow for the auction simulator 505 as it does for actual auctions. But it should be unmistakable to users that the simulated auction is, indeed, simulated. The simulated auction lifecycle (10-minute cycles) is:
Auction Announcement: 1 minute
Auction Countdown: 1 minute
Auction Open: 5 minute duration.

Auction Closed: 30 seconds
Auction Results: 2.5 minutes.
   Either winning allocation or non-winning statement may be published. The functionality of the auction simulator 505 may be the same as the regular auction interface. Pre-auction bids may not be accepted for the simulated auction. Fictitious bids may automatically be generated throughout the 5-minute auction duration such that the auction may clear in the absence of any human intervention. The system should offer administrators the ability to “tune” simulation clearing price, terms, and timing.

When a current auction is selected from the current auctions page 507, an auction terms page 508 may be provided for specification of the deal setup terms, including the Auction Open Time (OT) and an Auction Close Time (CT). These may be timestamp variables of the format: [MM:DD:YYYY HH:MM:SS.MMM]. In order to define what time variable is displayed on the external user pages, at a given point in the auction, an Auction Timing Expression field may also be available. This expression may be a free-form text value, but it may leverage the mechanical values set in the auction chronology. The Auction Timing Expression may allow the Auctioneer 106 to control what is displayed to bidders at the exact start time of an auction, which may become more precise as the day of the auction nears. For example:
“Mechanical” Auction Open Time: 2006-06-07 16:10:00.000
“Mechanical” Auction Close Time: 2006-06-07 16:25:00.000
   Auction Timing Expression: &OT[EEEE, MMMM d] after market close, would display in the Investor viewed terms and auction lists as: Wednesday, June 7 after market close. Auction Timing Expression: &OT[EEEE, MMMM d] at approximately &OT[h:mma zzz], would display in the Investor viewed terms and auction lists as: Wednesday, June 7 at approximately 4:10 PM EDT. Similarly, as the auction countdown state approaches, the Auctioneer 106 can change the expression in deal terms to reflect the actual system times for display, for example: Auction Timing Expression: &OT[MM/dd/yyyy, h:mma]-&CT[h:mma zzz], would display in the bidder viewed terms and auction lists as: Jun. 7, 2006, 4:10 PM-4:25 PM EDT.

After presenting the auction terms 508, a user agrees to the auction participation agreement 509 (which generates a participation agreement report 510) and the user's account is now ready for bidding 511 on the selected auction. Before the auction starts, the user may be allowed to enter a pre-bid 512, for example, as shown in FIG. 5, pre-bids may be entered from underwriter capital markets and various dealers (e.g., via an underwriter price point aggregation 513).

Once the auction starts 514, bids are accepted 515, with bids being entered 516, modified 517, and/or cancelled 518 until the bidding ends 519 at the auction close time. The winning bid allocations are calculated and reviewed 521 and revised or changed as necessary 522. Final winning bid allocations approved 523 and published 524, ending the auction 525.

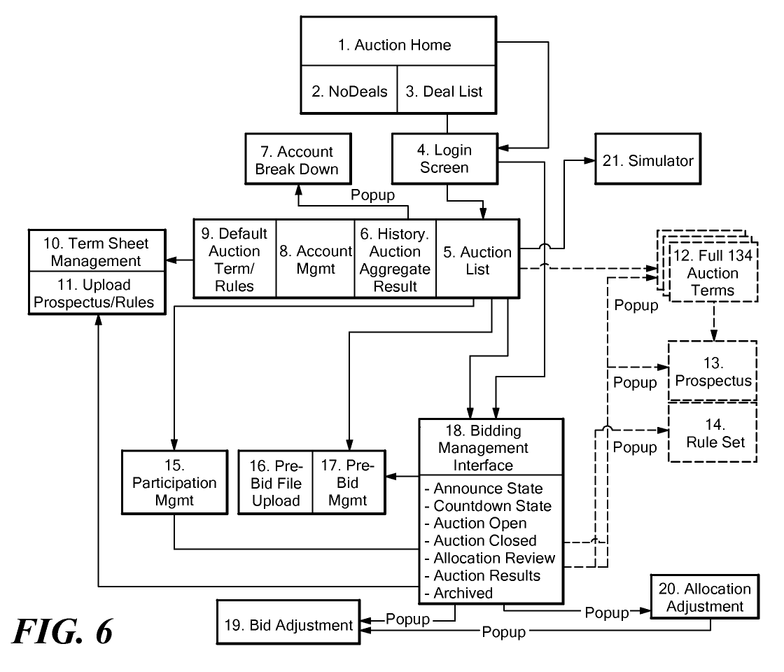

The application workflow for auction bidders, dealers, underwriter users may be described as follows, where entitlements control the screen access. The Auctioneer 106 has the most complete entitlement and screen access in the auction process, so the auctioneer experience may be used to outline the complete application workflow. While the screen access may change based upon entitlement access, the navigation may not. The workflow process for the auctioneer is shown in FIG. 6 and summarized in the following table:

| | Process | Description |
|---|---|---|
| 1 | Auction | This will be the public home page for the auction site. On this |
| | Home | home page, the current announced, countdown and open auction |
| | | list will be shown. |
| 2 | No Deals | If there are no available auctions, the user may still log into the |
| | | site to view their past auction results. |
| 3 | Deal List | If more than one auction is available, the public 134 information |
| | | will be displayed. The user can either (a) log in to the system |
| | | without clicking on an auction and be taken to #5, the auction list. |
| | | Or, they can click on a deal and be taken directly to the |
| | | bidding management interface for that specific auction, via the |
| | | login screen. |
| | | NB: The Auctioneer does not need to review the participation |
| | | agreement before proceeding to an auction, whereas external |
| | | bidders will be required to agree to the participation agreement. |
| 4 | Login Screen | UserID and password validation to control entitlement access. |
| 5 | Auction List | List of auctions that are either announced, in countdown or open |
| | | states. The user can click on one of the auctions to proceed to the |
| | | bidding management interface. |
| | | The Auctioneer will also be able to view the pre-bids that have |
| | | been uploaded for a specific auction and remove any individual |
| | | bid from a price point. Pre-bids from Investors are entered in |
| | | the bidding management interface. |
| | | From the auction list, the Auctioneer can also manage the |
| | | participants for each of the auctions. |
| 6 | History. Auction | The History tab will display the aggregate result for each auction, |
| | Aggregate | clicking on one of the auctions will open up a separate window |
| | Result | with the allocation breakdown. This will only be available for |
| | | the Auctioneer; bidders will just see their winning or unsuccessful |
| | | attempt in the aggregate result window. |
| 7 | Account | For the Auctioneer, this displays the full transparency winning |
| | Breakdown | allocation data for each archived auction. |
| 8 | Account | This tab will allow the Auctioneer to manage the user set-up |
| | Management | preferences, from basic client details to purchase limits and bid |
| | | prices. |
| 9 | Default Auction | This tab will allow a generic or default set of auction terms and |
| | Terms/Rules | rules to be maintained. These can then be used as a |
| | | baseline/template to configure each individual auction. |
| 10 | Term Sheet | This tab will allow the Auctioneer to specify the Auction specific |
| | Management | terms; they can be modified at any time from this screen. |
| 11 | Upload | The Auctioneer can upload the prospectus for each auction, as |
| | Prospectus/Rules | well as either the generic auction rules or specific auction rules. |
| | | This tab will be used to make any modifications to this data. |
| 12 | Full 134 Auction | Available to all users, displays a read only pop-up of the 134 |
| | Terms | auction terms. This is accessible from either the auction list |
| | | or the bidding management interface. |
| 13 | Prospectus | Available to all users, displays a read only pop-up of the auction |
| | | prospectus accessible from the bidding management interface. |
| 14 | Rule Set | Available to all users, displays a read only pop-up of the auction |
| | | rule-set accessible from the bidding management interface. |
| 15 | Participation | Accessible from auction list, the Auctioneer can mark any |
| | Management | participants that are not allowed access to specific auctions. This |
| | | is not the same as deactivating and account which would be |
| | | performed from account management. |
| 16 | Pre-Bid Upload | The Auctioneer will also be able to upload a file with pre-bids; a |
| | | dealer with accounts will also have access to this screen. So it is |
| | | envisaged this may be more of a support process for the |
| | | Auctioneer. |
| 17 | Pre-Bid | The Auctioneer can view both the aggregate price point bids and |
| | Management | detail breakdown for retail bids that have been uploaded. From this |
| | | screen they will also be able to remove the individual bid from the |
| | | price-point aggregation. |
| 18 | Bidding | The bidding management interface is the core screen of the |
| | Management | application that all users will have access to, however, |
| | Interface | functionality within the screen is driven by the entitlements. |
| | | The auctioneer will have full auction control within this screen |
| | | over the bid-stack, auction monitoring, the auction countdown and |
| | | bid state changes. |
| 19 | Bid Adjustment | If the Auctioneer needs to either enter, modify or delete a bid from |
| | | the bid-stack, the bid adjustment window will allow them to do so. |
| | | This is a pop-up window from the bidding management interface. |
| 20 | Allocation | Once the auction has been completed, the allocations can be |
| | Adjustment | reviewed and modified, and if required, a short or long position |
| | | taken on by the underwriter. The allocation adjustment window will |
| | | provide the functionality for these activities and is accessible as a |
| | | new pop-up window from the bidding management interface. |
| 20 | Simulator | The auction simulator is available as a separate window from the |
| | | auction list. The simulator will utilize a different scheme from |
| | | live auctions to illustrate that it is not a live auction. |

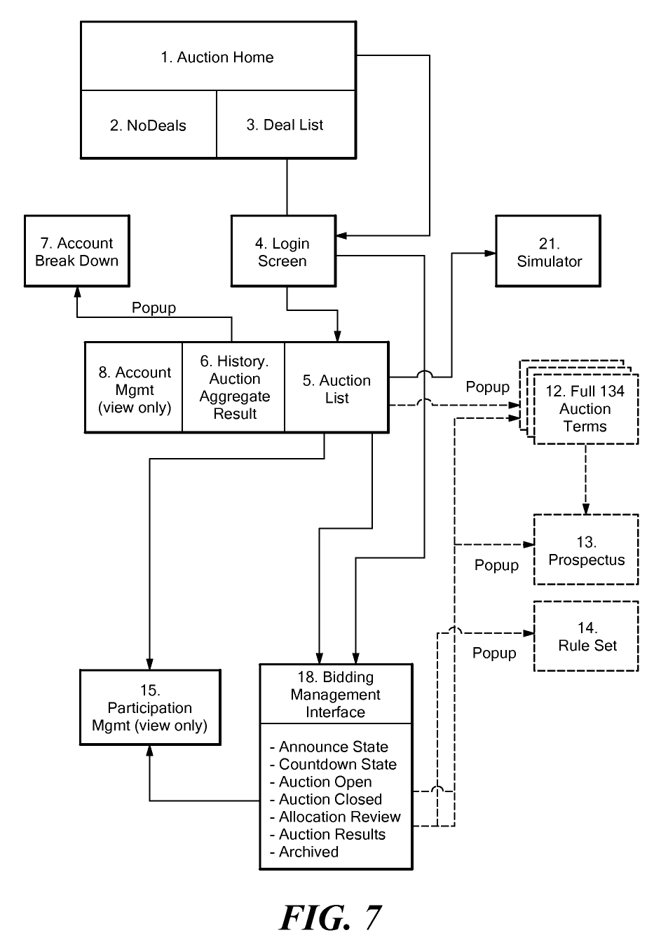

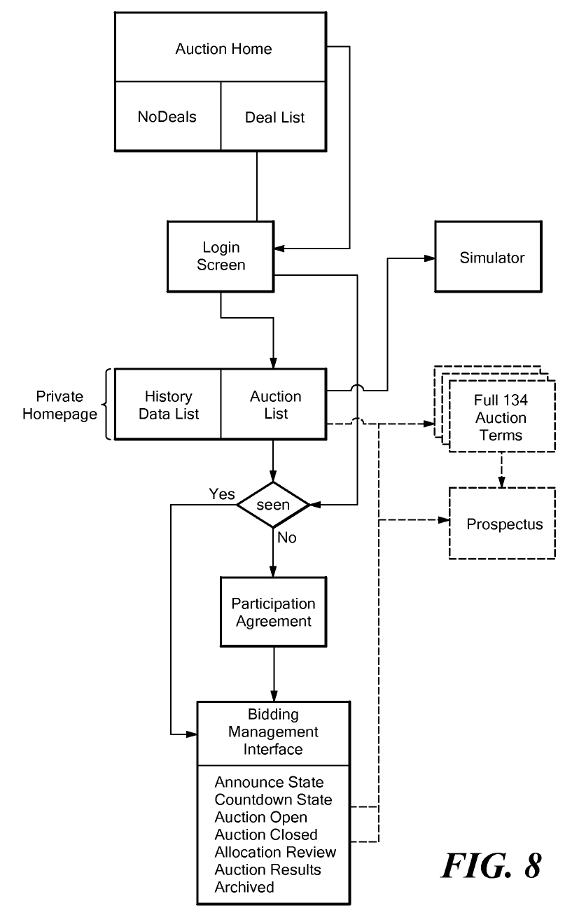

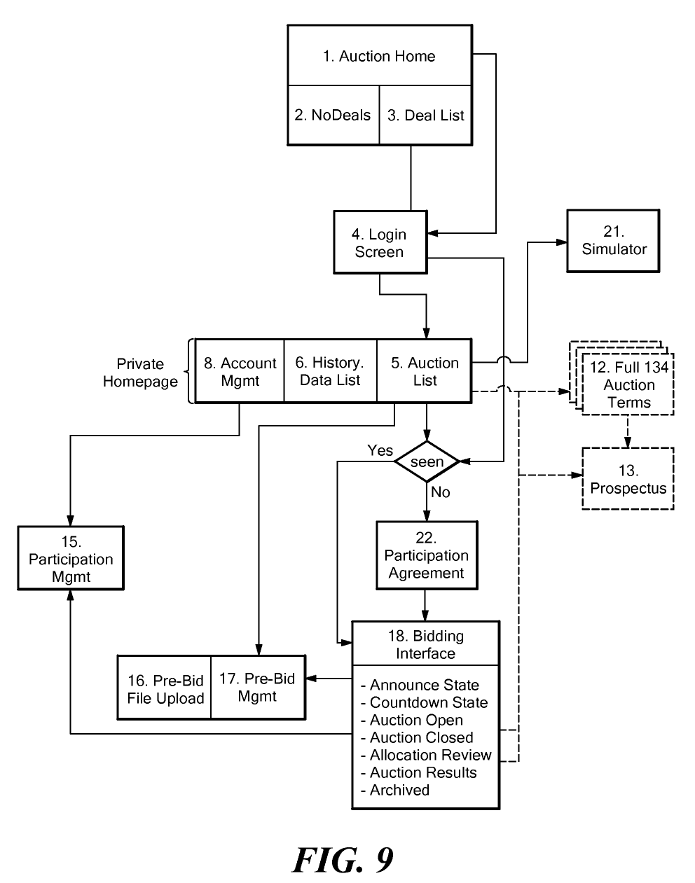

The workflow processes are similar for sales management (FIG. 7), the auction bidder (FIG. 8), and the auction dealer with accounts (FIG. 9). One difference with the auction bidder (and any other external user) is the addition of the participation agreement. Before the auction bidder enters into the bidding management interface from either the deal list or the auction list, they need to click through and agree to the participation agreement once for each auction. The system may remember this action so that the user may not be forced back through this process if they leave the auction or log out of the system. Aside from that extra process, the workflow remains the similar with the difference being reduced information or actions available on each screen due to the entitlements. An auction dealer with accounts may have access to the participation management screen whereas a dealer without accounts may not have access to this information. Otherwise, the workflow for dealers remains similar. Dealers may also have access to the pre-bid screens to manage the pre-bid upload and removal after price point aggregation.

In one specific embodiment, underwriters purchase stock from an issuer for sale at auction, provided certain pre-conditions are met. The underwriters purchase the shores of stock from the issuers at a public offering price, less any underwriting discounts and commissions. An underwriting agreement provides that the obligations of the underwriters are subject to conditions as to the material condition of the issuer, including the absence of any material adverse change in the issuer's business, and the receipt of certificates, opinions and letters from issuer, their counsel, and independent accountants. Subject to those conditions, the underwriters are committed to purchase all the offered shares of common stock if any of the shares are purchased. However, the underwriters may not be required to take or pay for the shares covered by an underwriters' over-allotment option.

The underwriters may anticipate that after effectiveness of the registration statement and prior to commencement of the live auction described below, one or more standby purchasers not affiliated with the issuers or underwriters may agree to enter into standby purchase agreements with the underwriters. Pursuant to the terms of these standby purchase agreements, each standby purchaser may commit to purchase up to a fixed number of shares being sold in the offering at a purchase price referred to as the standby purchase commitment price. Issuer may receive standby purchase commitments for up to the full number of shares being offered in the offering, potentially including any shares subject to the underwriters' over-allotment option as described below. Standby purchasers are not able to participate in the live auction. A standby purchaser may not be allocated any shares in the offering if the auction clearing price, as described below, is above the price of that standby purchase commitment. Each standby purchaser may place one standby purchase commitment. To the extent there is more than one standby purchase commitment, the standby purchase commitments may vary in price and in size. The price and size of each standby purchase commitment may be determined prior to commencement of the auction and may be displayed during the live auction on the auction website. The price and size of the standby purchase commitments also may be communicated to any investors that submit pre-auction bids as described below.

In some specific embodiments, the issuer may grant the underwriters an option to purchase additional shares of our common stock at the offering price, less the underwriting discount. To the extent that the underwriters exercise this option, the underwriters undertake a firm commitment to purchase the additional shares, and the issuer may be obligated to sell the additional shares to the underwriters. The underwriters may exercise this option only to cover any over-allotments made in connection with the sale of shares offered.

The underwriters typically propose to offer the shares of the issuer's common stock directly to bidders in an auction, including any standby purchasers that receive an allocation, at the price reflected by mutual agreement, and to certain dealers at this price less a concession not in excess of a per share discount. The underwriters may allow, and dealers may reallow, a concession not to exceed an agreed on amount per share on sales to other dealers. After completion of the public offering of the shares, if all the shares are not sold at the offering price, the public offering price and other selling terms may be changed by the underwriters.

The per-share and total compensation to be paid to the underwriters by the issuer may be set forth in a table in connection with the offering. The underwriting discount may be determined through negotiations between the issuer and representatives of the underwriters, and be calculated as a percentage of the offering price. If any standby purchasers agree to enter into standby purchase agreements and submit standby purchase commitments, the underwriters pay each standby purchaser a commitment fee. This standby commitment fee is calculated as a percentage of the aggregate size of the standby commitment and determined through negotiations by and among the underwriters and each standby purchaser. The standby purchase commitment fee is typically paid by the underwriters to any standby purchasers that submit standby purchase commitments irrespective of whether the standby purchaser is allocated shares in the offering through the auction process described below.

The distribution method used by the underwriters in the offering (e.g., the auction process offered by W.R. Hambrecht+Co.) differs from the distribution method traditionally employed in underwritten public offerings. In particular, the public offering price is based on the results of an auction conducted by the underwriters. Bids may be submitted by interested purchasers in the live auction, or through a pre-auction bid submission through a participating underwriter or dealer. The allocation of shares of our common stock is determined by the auction process; however, the underwriter reserves a right to round off allocations to eliminate odd-lots.

The auction is held on the underwriter's web site which also sets forth the rules governing the auction. Shares offered may not be sold nor may offers to buy be accepted prior to the time that the registration statement filed with the Securities and Exchange Commission has become effective. A bid received by underwriter involves no obligation or commitment of any kind prior to the effectiveness of the registration statement and the commencement of the auction. When the auction closes, all bids that have not been modified or withdrawn by the bidder prior to the auction close may be considered firm and may be accepted. Bidders may cancel their bid at any time prior to the auction close and the notice of acceptance being sent. Bidders may modify or cancel their bids through the live auction website or by contacting the dealer or underwriter through which they submitted their bid by email, fax or telephone. There may be no guarantee that any bidder that elects not to participate in the live auction may be able to contact the underwriter or dealer through which they submitted their pre-auction bid during the live auction to cancel their bid.

Bids are submitted as limit bids in which the bidder specifies the number of shares the bidder is willing to purchase and the maximum price per share it is willing to pay for the shares. Each bidder is permitted to place no more than one limit bid. Each auction participant (other than a standby purchaser) may have a maximum bid size equal to the lesser of (a) 10% of the shares offered or (b) the credit limit of the bidder, as determined by the underwriter or dealer through which the bidder submits its bid. In certain circumstances, underwriter and the issuer may allow a bidder to bid for an amount of shares exceeding 10% of the shares offered.

If there is a minimum bid price in the auction, it may be displayed on the auction web site prior to commencement of the auction. If there is no minimum bid price in the auction, bids may be entered at any price, subject to the bidder's credit limit. If there are standby purchase commitments for all of the shares offered in the offering (including the shares subject to the underwriters' over-allotment option), then the minimum bid price in the auction may equal the price of the lowest priced standby purchase commitment. The underwriters and selling group members contact potential investors with information about the auction and how to participate and solicit bids from prospective investors through the Internet, telephone and facsimile.

The live auction may be open only to bidders who receive a user ID and logon password from an underwriter or participating dealer which may enable them to participate in the live web-based auction. Typically, only institutional or other high-net worth investors interested in purchasing significant blocks of stock may participate in the live auction. A selling group member may host a link to the auction web site from their respective web pages, and underwriter may provide user IDs and logon passwords to so that bidders may participate in the auction. Underwriter acts as the auction manager for the live auction and reserves the right to limit the number of participants in the live auction. If a bidder is approved to participate in the live auction, the bidder may be able to access the auction web site.

The auction web site may provide the following:

an electronic copy of the registration statement;

the number of shares being offered (including any over-allotment shares);

the maximum bid size for that particular customer;

the price increments for bids submitted in the auction;

the times that the auction may open and close;

any free writing prospectus or other written selling material used in connection with the offering;

a click-through form of offering participation agreement; and

the rules governing the auction.

During the auction, auction bidders participating in the live auction are able to view the following information, updated on a near real-time basis:

an advisement to the bidder that its bid has been submitted;

the graphic display of auction information updated at 10 second intervals during the auction showing the bids which have been placed at each price level within the displayed price range (including any standby purchase commitments) and aggregate demand outside the displayed price range;

a tabular display listing the size and price of all individual bids (including the size and price of any standby purchase commitments);

the current clearing price (taking into account any standby purchase commitments received);

notice that the auction has been completed; and

a notification that a bid has been accepted and shares have been allocated to a particular bidder or that a bidder has not received shares in the auction.

There typically are two primary information screens that provide bidders information about the auction progress—a tabular display and a graphic display. Throughout the live auction the tabular information display on the auction web site contains information on every bid submitted in the auction, including the standby purchase commitments. The graphic display of auction information may generally be set to display as much of the live-auction demand as possible (including any standby purchase commitments within the displayed range) with indications at either end of the displayed range as to the demand that is outside of the displayed information. Bids may be submitted in the live auction at prices outside the range displayed in the graphic display of the auction; however, these bids may only be displayed as part of aggregate demand above or below the displayed price range, unless the displayed price range is subsequently adjusted to include the price point of the bid. Underwriter may reserve the right, in its sole discretion, to adjust the price range displayed in the graphic auction display in order to facilitate the orderly progression of the auction.

Bidders participating in the live auction may modify their bid to increase or decrease the number of shares bid for or the price bid per share or may withdraw their bid or reenter the auction at any time prior to the close of the auction. When the auction closes, all bids that have not been withdrawn are considered firm and may be accepted by the underwriters.

If a bid is below the clearing price, the bidder may not receive any allocation of shares in the auction. The identity of auction participants and any standby purchasers may remain anonymous throughout the auction.

The auction may open shortly at a specific auction start time on the date specified by the underwriters, and may close a pre-determined number of minutes after the auction opens, at an auction end time disclosed on the auction web site. If a malfunction or other technical or mechanical problem occurs that the underwriters believe may interfere with the auction, the underwriters may extend the auction for up to an additional 30 minutes, cancel and reschedule the auction, or, if the technical problems cannot be resolved, revert to a traditional distribution method in which the price and allocation of the shares offered is within the sole discretion of the underwriters. Any such decision may be communicated by email, telephone, fax and/or posted on the auction web page.

Investors that are customers of one of the underwriters or participating dealers may enter a limit bid through the underwriter or dealer prior to the commencement of the live auction. These bidders may also participate in the live auction in order to modify or cancel their bid during the live auction through the auction web site. A pre-auction bid may be cancelled at any time up until the auction closes and the notice of acceptance is sent, however, it may be difficult or impossible for a bidder who has submitted a pre-auction bid to contact the underwriter or dealer through which they submitted their bid and cancel their bid in the brief time span of the live auction if they do not elect to participate in the live auction. All pre-auction bids may be entered into the auction immediately upon commencement of the auction and may be accepted by the underwriters once the auction closes. If a pre-auction bid is below the clearing price, the bidder may not receive an allocation of shares in the offering. Any limit bid entered into the auction at the commencement of the auction should specify a number of shares and the maximum price that the bidder is willing to pay for such shares. Such bids may receive the earliest possible time stamp in the auction, which may result in such bids receiving a higher allocation of shares bid for than subsequently placed orders. The underwriters and participating dealers may notify any pre-auction bidders of the prices and sizes of any standby purchase commitments via the auction website, email, telephone or facsimile.

After effectiveness of the registration statement, but prior to commencement of the live auction, the issuer and the underwriters anticipate that one or more standby purchaser(s) may enter into standby purchase agreements. The standby purchase agreements may commit each standby purchaser to purchase up to a fixed number of shares at a set price, referred to as the standby purchase commitment price. Each standby purchaser that has entered into a standby purchase agreement with the underwriters may submit an individual standby purchase commitment in the auction. Each standby purchaser may be allowed to submit more than one standby purchase commitment and the prices and sizes of the standby purchase commitments may vary. Issuer may receive standby purchase commitments for up to the full number of shares being offered (including any shares subject to the underwriters' over-allotment option described below).

Once the live auction has commenced, the price(s) and size(s) of the standby purchase commitments cannot be changed. If the auction results in an allocation of shares to a standby purchaser the standby purchaser may be obligated to purchase the shares that the standby purchaser agreed to purchase prior to the commencement of the auction. The standby purchasers may not be allowed to participate in the auction live auction or to pre-submit any other bids in the auction. The standby purchasers are not broker-dealers. The standby purchasers may purchase the shares in the ordinary course of their business, with investment intent. The prices and specific sizes of the individual standby purchase commitments may be disclosed during the live auction.

The highest auction price at which all of the shares offered can be sold in the auction is the “clearing price.” The calculation of the clearing price includes the shares subject to the underwriters' over-allotment option whether or not the over-allotment option is actually exercised by the underwriters. All shares may be sold to bidders and standby purchasers (if any) at the clearing price. If the clearing price obtained in the live auction is higher than the highest standby purchase commitment price, the standby purchaser(s) may not receive any shares in the offering. If the clearing price is equal to or below any standby purchase commitment price, the standby purchase commitments that equal or exceed the clearing price may only be allocated shares after all other bids submitted in the auction that equal or exceed the clearing price have received a full allocation of shares.

All bids entered in the auction may receive a time stamp equal to the nearest 10 second increment during which the bid was entered. Bids entered into the auction prior to the commencement of the auction by underwriters or participating dealers may be given the earliest time-stamp in the auction. If a bid is cancelled and then reentered into the auction, it may receive a new time stamp. Any change in the number of shares or price per share of a bid during the live auction may be treated as a new bid and given a new time stamp, except that the quantity of any bid may be increased by up to 50% from the original amount without losing the original time stamp.

If more shares are bid for at or above the clearing price than are offered, shares may be allocated based first on price and then on the time stamp. Bidders that bid a higher price than the clearing price may receive a full allocation of shares. Bidders that bid at the clearing price may receive allocations based on time stamp, with an earlier time stamp being allocated first. If two or more bids at the clearing price have the same time stamp (which is also the latest time stamp), they may be allocated a pro-rata number of shares based on the number of shares bid for.

If the clearing price is higher than the highest standby purchase commitment price, the standby purchasers may not receive any shares in the offering. If the clearing price is equal to or below any standby purchase commitment price, the standby purchase commitments that equal or exceed the clearing price may only be allocated shares after all other bids submitted in the auction that equal or exceed the clearing price have received a full allocation of shares. If there are two or more standby purchase commitments at prices that equal or exceed the clearing price, the standby purchasers with standby purchase commitments at prices equal to or exceeding the clearing price may receive a pro-rata allocation of the remaining shares (after fully allocating shares to the auction participants that bid at or above the clearing price) based on the size of the standby purchase commitments.

All accepted bids that are pro-rated generally may be rounded to the nearest 100 shares. If possible, bidders who would be pro-rated fewer than 100 shares may be rounded up to 100 shares. In no case may the rounded amount exceed the bid size.

The auction may close at the auction end time specified on the auction web site. After the auction closes, the underwriters and participating dealers may notify bidders whose bids have been accepted by providing notice through the auction web site or by e-mail, telephone or facsimile. Other bidders may be notified that their bids have not been accepted by e-mail, telephone or facsimile. Following the close of the auction, the web site and the final prospectus supplement may contain disclosure about the results of the auction.

The shares offered may be purchased from the issuer by the underwriters and sold through the underwriters to investors who have submitted successful bids prior to or in the auction and/or the standby purchasers, to the extent that any shares are allocated to the standby purchasers.

Embodiments of the invention may be implemented in any conventional computer programming language. For example, preferred embodiments may be implemented in a procedural programming language (e.g., “C”) or an object oriented programming language (e.g., “C++”). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which may achieve some of the advantages of the invention without departing from the true scope of the invention.

What is claimed is:

1. A method for auctioning securities, the method comprising:
defining an auction start time and an auction end time, the time therebetween being defined by a plurality of transparency intervals;
at the auction start time, commencing a real-time auction of securities over a communications network, including receiving bids from prospective purchasers;
at the end of each transparency interval:
i. updating public bid information related to the auction, and
ii. making the updated public bid information available to the prospective purchasers; and
after the auction end time:
i. establishing a final auction price for the securities based upon the bids made during the auction, and
ii. allocating the securities to the prospective purchasers at the final auction price.

2. A method according to claim 1, wherein the auction is a multi-round auction.

3. A method according to claim 1, wherein the auction is further defined by a privacy period between the last update of public bid information and the auction end time, during which bids can be received but no further transparency interval updates are made available to the prospective bidders.

4. A method according to claim 1, wherein the bids include:
i. live bids which specify a number of shares of the securities to be purchased at a current price, and
ii. limit bids which specify a number of shares of the securities to be purchased and a maximum price per share.

5. A method for auctioning securities, the method comprising:
defining an auction start time and an auction end time, the time therebetween being
defined by a plurality of time bucket intervals;
at the auction start time, commencing a real-time auction of securities over a communications network, including, during each time bucket interval:
i. receiving bids from prospective purchasers, and
ii. assigning a time bucket stamp to each received bid such that bids with the
same time stamp are treated as having occurred at the same time; and
after the auction end time:
i. establishing a final auction price for the securities based upon the bids made during the auction, and
ii. allocating the securities to the prospective purchasers at the final auction price.

6. A method according to claim 5, wherein the auction is a multi-round auction.

7. A method according to claim 5, wherein bids can be received before the auction start time and receive the time bucket stamp for the first time bucket interval.

8. A method according to claim 5, wherein the bids include:
i. live bids which specify a number of shares of the securities to be purchased at a current price, and
ii. limit bids which specify a number of shares of the securities to be purchased and a maximum price per share.

9. A method for auctioning securities, the method comprising:
defining an auction start time and an auction end time, the time therebetween being defined by:
i. a plurality of time bucket intervals, and
ii. a plurality of transparency intervals;
at the auction start time, commencing a real-time auction of securities over a communications network, including, during each time bucket interval:
i. receiving bids from prospective purchasers, and
ii. assigning a time bucket stamp to each received bid such that bids with the same time stamp are treated as having occurred at the same time;
at the end of each transparency interval:
i. updating public bid information related to the auction, and
ii. making the updated public bid information available to the prospective purchasers; and
after the auction end time:
i. establishing a final auction price for the securities based upon the bids made during the auction, and
ii. allocating the securities to the prospective purchasers at the final auction price.

10. A method according to claim 9, wherein the auction is a multi-round auction.

11. A method according to claim 9, wherein the time bucket interval equals the transparency interval.

12. A method according to claim 9, wherein the time bucket interval is a multiple of the transparency interval.

13. A method according to claim 9, wherein the auction is further defined by a privacy period between the last update of public bid information and the auction end time, during which bids can be received but no further transparency interval updates are made available to the prospective bidders.

14. A method according to claim 9, wherein bids can be received before the auction start time and receive the time bucket stamp for the first time bucket interval.

15. A method according to claim 9, wherein the bids include:
i. live bids which specify a number of shares of the securities to be purchased at a current price, and
ii. limit bids which specify a number of shares of the securities to be purchased and a maximum price per share.
